(19) United States
(12) Patent Application Publication
(10) Pub. No.: US 2007/0255553 A1
(43) Pub. Date: Nov. 1, 2007

(54) Information Extraction System

(75) Inventor: Masako Nomoto, Saitama-ken (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 10/599,507

(22) PCT Filed: Mar. 31, 2005
(86) PCT No.: PCT/JP05/06317

§ 371 Date: Sep. 29, 2006

(30) Foreign Application Priority Data
Mar. 31, 2004 (JP) 2004-107139

(51) Int. Cl. G06F 17/27

(52) U.S. Cl. 704/9

(57) ABSTRACT

Contents of a description such as a fact and an opinion related to a thing expressed in a text are extracted with a viewpoint of the fact and the opinion related to a description. To execute it, there are provided an input unit that inputs a text, a viewpoint and description extraction rule storage that stores a viewpoint and description extraction rule for specifying a pair of a viewpoint of an expression described in the text and a description of the viewpoint, a viewpoint and description extraction unit that relates the pair of the viewpoint and its description based upon at least one of a syntactic attribute and a semantic attribute of a character string in the text using the viewpoint and description extraction rule and extracts the pair as element metadata including identification information for identifying the pair, and a metadata storage that stores the element metadata extracted by the viewpoint and description extraction unit. The contents of a description such as a fact and an opinion related to a thing expressed in the text are configured as a pair of a viewpoint and a description, are arranged in a form in which the fact and the opinion are related, and are extracted.

### FIELD OF THE INVENTION

The present invention relates to an information extraction system that extracts contents of description such as a fact and an opinion written in relation to a thing from a text.

### BACKGROUND OF THE INVENTION

For a conventional type information extraction system, a system that extracts a keyword from a text, a system that extracts a proper noun and numeric representation, a system that extracts information related to a fact such as when, where, who, what, why and how and a system that extracts an opinion and reputation are known. In information extraction in a narrow sense, central information in a text is extracted as described on pp. 438 to 441 in “Natural language process” written by Nagao and others and published by Iwanami Shoten in 1996, and it is typical to prepare a template (or a frame) of information to be extracted with a text in a specific field as an object and extract the corresponding information. In the meantime, researches for extracting an opinion and reputation in a text are recently in progress. For example, in JP-A-2003-203136, opinions related to a thing specified by a user are extracted from a document set.

However, although a conventional type opinion information extraction system disclosed in JP-A-2003-203136 can extract an opinion related to a thing, the opinion information extraction system has a problem that it cannot extract a viewpoint of a fact and an opinion respectively written in relation to the thing and a description correlatively.

### SUMMARY OF THE INVENTION

The invention is made in view of such a problem and a first object is to provide an information extraction system that extracts the contents of description such as a fact and an opinion related to a thing expressed in a text with a viewpoint of the fact and the opinion and a description related.

A second object of the invention is to provide an information extraction system that can arrange and extract in a form that it is easy to relate a fact and an opinion and compare the relevance when the contents of description such as the fact and the opinion are extracted.

To solve the problem, the information extraction system according to the invention is provided with an input unit that inputs a text, a viewpoint and description extraction rule storage that stores a viewpoint and description extraction rule for specifying the pairs of a viewpoint and a description for an expression in the text, a viewpoint and description extraction unit that identifies the corresponding pairs of the viewpoint and its description of the expression using the viewpoint and description extraction rules that based on syntactic and/or semantic attributes and extract them as the element metadata to which identification information is added and a metadata storage that stores the element metadata extracted by the viewpoint and description extraction unit.

According to this configuration, the contents of a description such as the fact and the opinion related to the thing expressed in the text are related as the pair of the viewpoint and the description and can be extracted. Further, a fact and an opinion extracted by a subsequent process can be arranged in a form that it is easy to compare relevance.

As described above, the information extraction system according to the invention has an effect that it can correlatively extract the contents of description such as a fact and an opinion related to a thing expressed in a text as a pair of a viewpoint and a description by correlatively extracting the pair of the viewpoint and the description using a viewpoint and description extraction rule for specifying the pair of the viewpoint of an expression described in the text and the description related to the viewpoint.

The objects and the advantages of the invention will be described will be more clarified by the following embodiments described referring to the attached drawings.

### BRIEF DESCRIPTION OF THE DRAWINGS

FIG. 1 is a block diagram showing the configuration of an information extraction system equivalent to a first embodiment of the invention;

FIGS. 2A to 2C are explanatory drawings showing a flow of a series of processes until element metadata is extracted from a text in the information extraction system equivalent to the first embodiment;

FIGS. 3A and 3B show an example of a viewpoint and description extraction rule and the definition of components of the rule in the information extraction system equivalent to the first embodiment;

FIG. 4 shows an example of integrated metadata in the information extraction system equivalent to the first embodiment;

FIG. 5 is a block diagram showing the configuration of an information extraction system equivalent to a second embodiment of the invention;

FIGS. 6A and 6B show an example of an input text and the text to which a semantic attribute is added in the information extraction system equivalent to the second embodiment;

FIGS. 7A and 7B show an example of a semantic attribute addition rule and an example of the definition of semantic attribute addition rule components in the information extraction system equivalent to the second embodiment;

FIGS. 8A and 8B show an example of a text with a semantic attribute and a viewpoint and description identification example in the information extraction system equivalent to the second embodiment;

FIGS. 9A and 9B show an example of a viewpoint and description extraction rule and the definition of components of the rule in the information extraction system equivalent to the second embodiment;

FIG. 10 shows an example of the result of extracting element metadata in the information extraction system equivalent to the second embodiment;

FIG. 11 shows an example of integrated metadata in the information extraction system equivalent to the second embodiment;

FIG. 12 is a block diagram showing the configuration of an information extraction system equivalent to a third embodiment of the invention;

FIGS. 13A and 13B show the result of identifying a viewpoint and a description and the result of extracting element metadata in the information extraction system equivalent to the third embodiment;

FIGS. 14A and 14B show an example of a topical thing estimation rule and the definition of components of the topical thing estimation rule in the information extraction system equivalent to the third embodiment;

FIG. 15 shows an example of estimated topical things in the information extraction system equivalent to the third embodiment;

FIG. 16 shows an example of integrated metadata in the information extraction system equivalent to the third embodiment;

FIG. 17 shows an example of a metadata output format in the information extraction system equivalent to the third embodiment;

FIG. 18 is a block diagram showing the configuration of an information extraction system equivalent to a fourth embodiment of the invention;

FIGS. 19A to 19D show an example of the source information and the user information of a text and an example of source information with a semantic attribute and user information with a semantic attribute in the information extraction system equivalent to the fourth embodiment;

FIGS. 20A and 20B show an example of a source information semantic attribute addition rule and a user information semantic attribute addition rule in the information extraction system equivalent to the fourth embodiment;

FIGS. 21A and 21B show an example of a source viewpoint and description extraction rule and a user viewpoint and description extraction rule in the information extraction system equivalent to the fourth embodiment;

FIGS. 22A and 22B show an example of the result of extracting source metadata and the result of extracting user metadata in the information extraction system equivalent to the fourth embodiment;

FIG. 23 shows an example of an objectivity/reliability determination rule and the definition of components of the objectivity/reliability determination rule in the information extraction system equivalent to the fourth embodiment;

FIGS. 24A and 24B show an example of a text and an example of the text with a semantic attribute in the information extraction system equivalent to the fourth embodiment;

FIGS. 25A and 25B show an example of a viewpoint and description extraction rule and an example of the definition of components of the viewpoint and description extraction rule in the information extraction system equivalent to the fourth embodiment;

FIG. 26 shows an example of the result of extracting element metadata in the information extraction system equivalent to the fourth embodiment;

FIG. 27 shows an example of the result of determining the objectivity and the reliability in the information extraction system equivalent to the fourth embodiment;

FIG. 28 shows an example of the result of integrating metadata in the information extraction system equivalent to the fourth embodiment; and

FIG. 29 shows an example of a metadata output format in the information extraction system equivalent to the fourth embodiment.

### DETAILED DESCRIPTION OF THE PREFERRED EMBODIMENTS

Referring to the drawings, embodiments of the invention will be described in detail below.

### First Embodiment

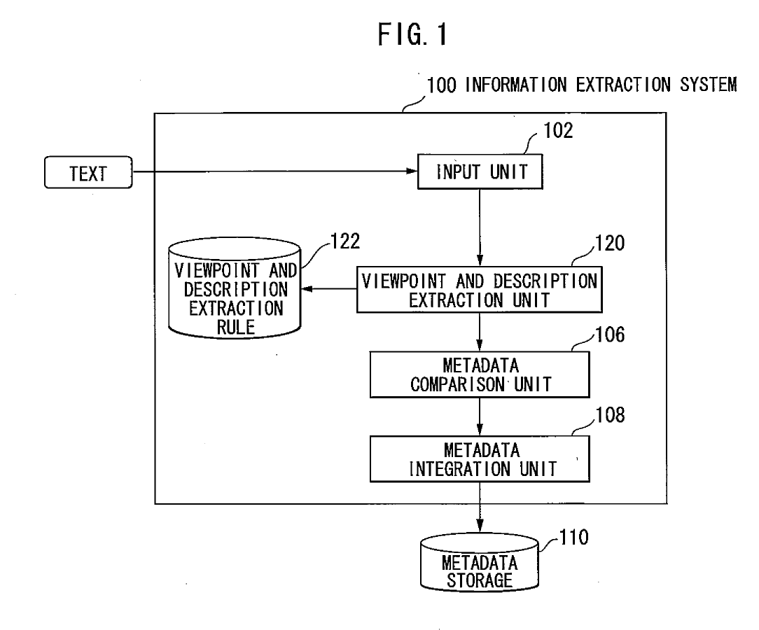

FIG. 1 is a block diagram showing the configuration of an information extraction system equivalent to a first embodiment of the invention. The information extraction system 100 equivalent to this embodiment is a system for configuring the contents of a description such as a fact and an opinion in relation to things expressed in an input text as a pair of a viewpoint and a description, arranging and extracting them to facilitate relating a fact and an opinion and the comparison of relevance. The information extraction system 100 is provided with an input unit 102 to which a text is input, a viewpoint and description extraction rule storage 122 for storing a viewpoint and description extraction rule for specifying a pair of a viewpoint of an expression described in the text and a description related to the viewpoint, a viewpoint and description extraction unit 120 that relates a pair of a viewpoint and its description based upon the syntactic attribute of a character string in the text using the viewpoint and description extraction rule and extracts them as element metadata which is equipped with identification information for identifying them, a metadata comparison unit 106 that compares and estimates the respective relationships between the viewpoints and between the descriptions of element metadata extracted by the viewpoint and description extraction unit, a metadata integration unit 108 that integrates related element metadata based upon the estimated relevance and a metadata storage 110 for storing integrated metadata which is metadata integrated by the metadata integration unit 108.

The hardware configuration of the information extraction system 100 is arbitrary and is not particularly limited. For example, the information extraction system 100 is realized by a computer provided with a CPU and a storage such as a ROM, a RAM, a hard disk and various storage media. As described above, when the information extraction system 100 is realized by the computer, predetermined operation is executed when the CPU executes a program in which the operation of the information extraction system 100 is described.

This information extraction system 100 first receives the text input to the input unit 102. The viewpoint and description extraction rule for specifying a pair of the viewpoint of an expression written in the text and a description related to the viewpoint is stored in the viewpoint and description extraction rule storage 122. The viewpoint and description extraction unit 120 relates contents described in relation to things based upon the syntactic attribute of a character string in the text referring to the viewpoint and description extraction rule stored in the viewpoint and description extraction rule storage 122 as a pair of a viewpoint and its description. Next, the viewpoint and description extraction unit extracts element metadata acquired by adding element metadata ID which is identification information for identifying the related pair to the related pair of the viewpoint and its description. The metadata comparison unit 106 respectively compares and collates viewpoints and descriptions in the extracted element metadata and estimates relevance. Further, the metadata integration unit 108 integrates element metadata having relevance based upon the relevance estimated by the metadata comparison unit 106 and stores the integrated element metadata as integrated metadata in the metadata storage 110.

Metadata generally means data showing information related to contents such as a bibliography. In the invention, the contents of the description of contents such as a fact and an opinion related to a thing expressed in the text as a pair of a viewpoint and a description are regarded as a basic unit of metadata and are particularly called element metadata. The above-mentioned fact means a matter objectively acknowledged to be the same by anyone and denotes a name (including a proper noun) of a thing, a date or quantity for example. The above-mentioned opinion means a view of how an individual thinks, feels or evaluates a thing and denotes “heavy”, “light”, “hot” and “insufficient” for example. The above-mentioned viewpoint means to what point of a thing a fact and an opinion related to the thing pay attention or from what view they are described. The above-mentioned description means by what expression a thing is concretely expressed in the text from the above-mentioned viewpoint. Only one of viewpoints and descriptions forming element metadata may be expressed in the text. When plural descriptions exist in relation to one viewpoint, the plural descriptions are extracted in relation to one viewpoint. Not only a pair of a viewpoint and a description but their attributes and related information such as a topic may also be included in element metadata. Element metadata in which respective related viewpoints, descriptions and related information in plural element metadata are integrated are called integrated metadata.

An element metadata ID which is identification information is added to element metadata. The element metadata ID is identification information added to individual element metadata for identifying the text including an element and individual element metadata. The syntactic attribute of a character string means an attribute related to a syntactic function of the character string and is specified by at least one of information for classifying a part of speech and information related to character string notation. The information related to character string notation is used for identifying a boundary between some of words and simple analysis such as identifying the continuation of nouns and punctuation using a postpositional particle is also enabled in a text in which no syntactic analysis is executed by using a type of a character for information related to character string notation for example.

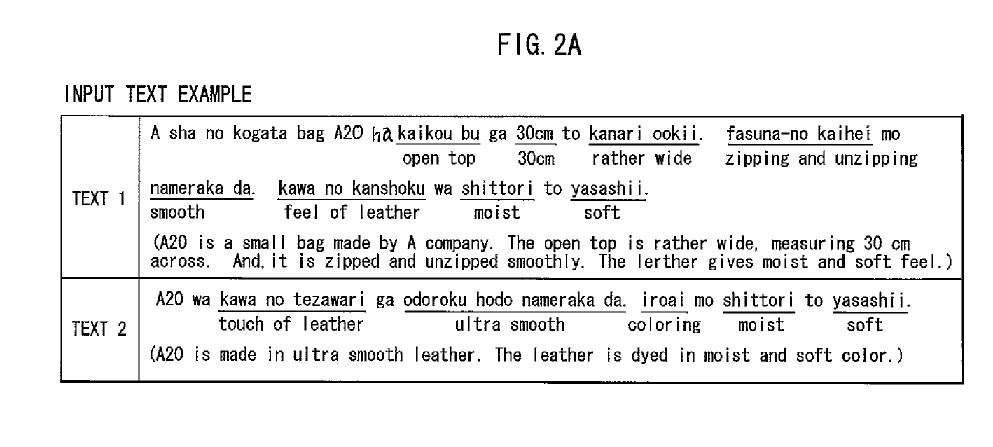

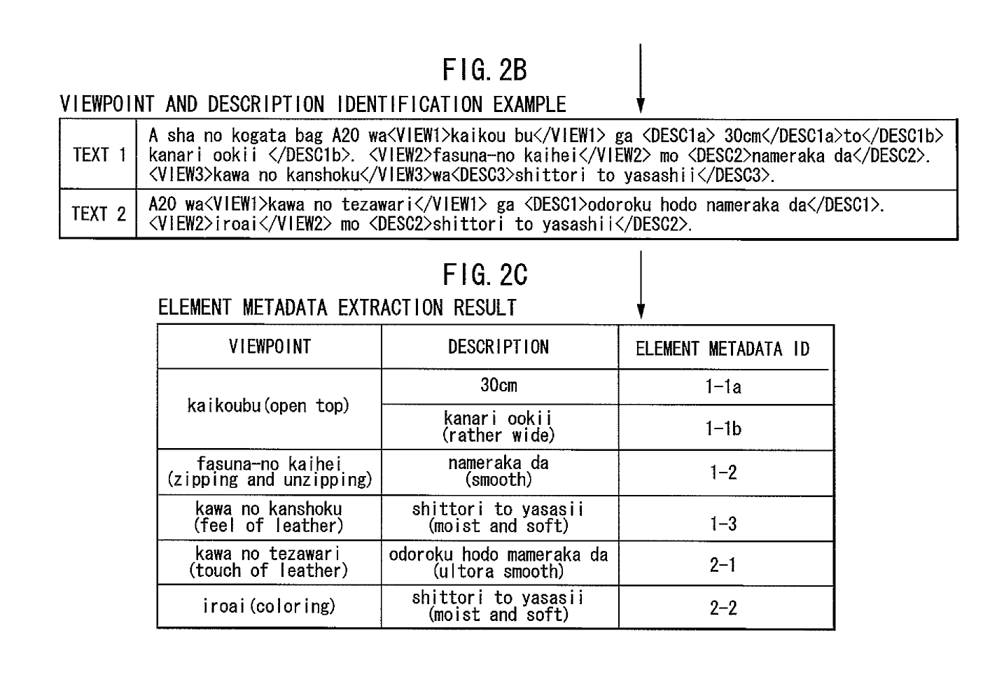

Next, the information extraction system 100 having the above-mentioned configuration will be described more detailedly using a concrete example. FIGS. 2A to 2C are explanatory drawing showing the outline of a series of processes until contents such as a fact and an opinion expressed in relation to a thing are extracted from an input text as element metadata. FIG. 2A shows an example of the input text, FIG. 2B shows an example in which a viewpoint and a description are identified, and FIG. 2C shows an example of the result of extracting element metadata.

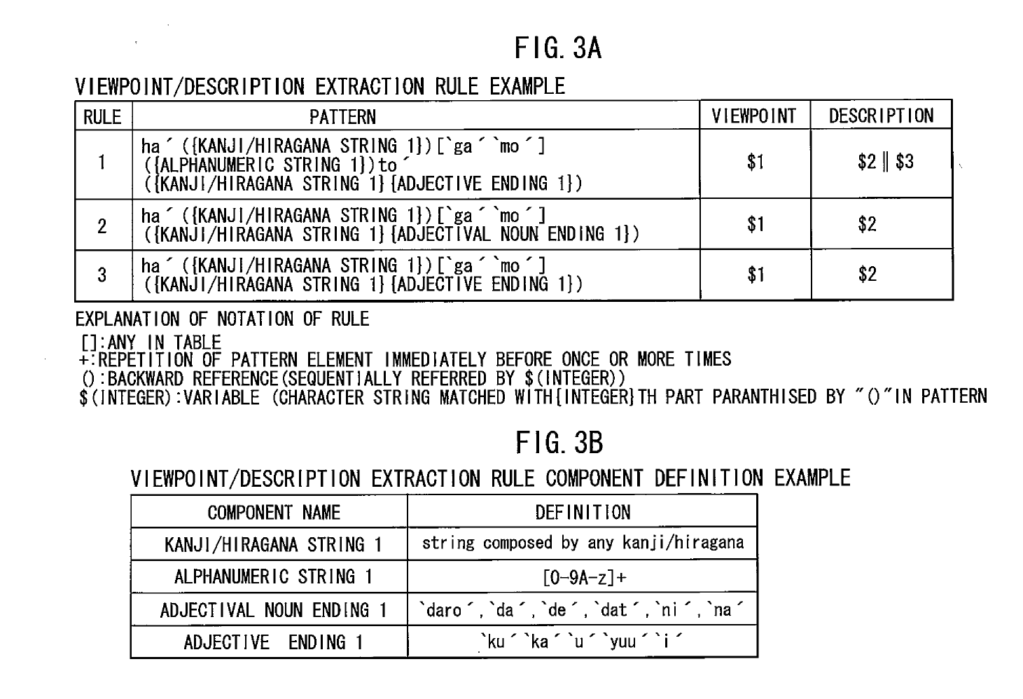

First, the viewpoint and description extraction unit 120 refers to the viewpoint and description extraction rule stored in the viewpoint and description extraction rule storage 122 and checks whether or not a character string in the text input from the input unit 102 has a syntactic attribute specified in a pattern in the viewpoint and description extraction rule. FIGS. 3A and 3B show an example of the viewpoint and description extraction rule and the definition of components of the rule. The definition of components of the rule means defining a character string used for describing a pattern and others in the rule as a component beforehand, and a name of a component described in the rule is regarded as equivalent to a character string defined with the component name. A method of defining a component name is not particularly limited if only the component name and the character string or a list of character string patterns can be related. For example, a component name and the corresponding character string or a list of character string patterns may also be described in one file or the corresponding character string, or the list of character string patterns may also be described in a different plurality of files. When the similar component is used in example described subsequently of the rule, the definition is omitted. A pattern for extracting a viewpoint and a description and locations corresponding to the viewpoint and the description in the pattern are shown in each rule.

A viewpoint and description extraction rule shown in FIG. 3A is a rule for extracting a viewpoint and a description using a syntactic attribute of a character string. In the pattern of the viewpoint and description extraction rule, the syntactic attribute of a character string equivalent to a viewpoint and description or a character string in its circumference is specified in character string notation or the classification of a part of speech. When the syntactic attribute is specified in character string notation, the syntactic attribute is described as a pattern of normal representation including a character string such as “ha” and a character string such as [ga mo] (which means either “ga” or “mo”) in the pattern of the rule or a component name defined beforehand such as “kanji/hiragana string 1” is specified. When the syntactic attribute is specified in the classification of a part of speech, a component name corresponding to a classified name of a part of speech is defined beforehand as “adjectival noun ending 1” and “adjective ending 1” and the defined component name is specified.

For a method of specifying the syntactic attribute of a character string, the character string notation and the classification of a part of speech are used in the description, however, the invention is not limited to these and syntactic relation may also be used in addition. When the character string notation and the classification of a part of speech are used, the method of specifying the syntactic attribute is not limited to the above-mentioned methods either and another method may also be used. In place of the syntactic attribute, a semantic attribute may also be used, both a syntactic attribute and a semantic attribute may also be used, and further in addition to these, another attribute such as a statistical attribute may also be used. A condition of applying the rule is specified in only the pattern of the rule in the description, however, a constraint on a part of the pattern may also be specified separately, and the condition may also be specified somewhere except the pattern.

In FIG. 3A, a location corresponding to a viewpoint and a description in the pattern is marked by “( )” and a marked part is referred in order of $1, $2, - - - from the head. For example, in the case of a rule 1, when <“ha”><kanji/hiragana string 1><“ga” or “mo”>, <alphanumeric character continuation 1>, <“to”>, <<kanji/hiragana string 1>, <adjective ending 1> emerges in this order in the text, it is matched with the pattern of the rule. A part equivalent to <kanji/hiragana string 1> marked by first “( )” in the pattern in a character string equivalent to the pattern in the text is referred as $1. A part equivalent to <alphanumeric character continuation 1> marked by second “( )” is referred as $2, and a part equivalent to <kanji/hiragana string 1><the adjective ending 1> marked by third “( )” is referred as $3. According to the rule, the part referred as $1 is extracted as a viewpoint and the parts referred as $2 and $3 are extracted as a description. The notation of the rule is not limited to the above-mentioned notation and another notation may also be used.

When the rule 1 shown in FIG. 3A is applied to a text 1 shown in FIG. 2A, “kaikou bu (open top)” in a first sentence is equivalent to a viewpoint, and “30 cm” and “kanari ookii (rather wide)” are equivalent to a description. In a viewpoint and description identification example shown in FIG. 2B, a viewpoint and description pair ID number for identification is added to a viewpoint and description pair in the text, the beginning and the end of an expression of the viewpoint are marked by <VIEW (number of viewpoint and description pair)> and </VIEW (number of viewpoint and description pair>, and the beginning and the end of an expression of the description are marked by <DESC (number of viewpoint and description pair)> and </DESC (number of viewpoint and description pair)>. A method of adding the viewpoint and description pair ID number is not particularly limited if only the viewpoint and description pair can be uniquely specified. For example, the identification information of the text and the number of the viewpoint and description pair in the text may also be combined.

When there are plural descriptions of “20 rittoru (20 liters)” and “ookii (large)” for one viewpoint (“capacity” in this example) as “youryou ga 20 rittoru to ookii (the capacity is as large as 20 liters)” for example, these are approved as different two descriptions based upon the same viewpoint. In an example of the viewpoint and description extraction rule according to the invention, when a different plurality of descriptions based upon the same viewpoint are approved, these descriptions are shown using a mark ‘ ’ like $1$1 $2′ (however, $1 and $2 are described) for example.

In the meantime, when its aim is limited to a trip for one viewpoint (“capacity” in this example) such as “youryou ga ryokouyou ni ha tiisai (the capacity is small for a trip)” for example, plural descriptions (“ryokouyou (for a trip)” and “tiisai (small)” in this example) may also be handled as one description if there is restrictive relation like “tiisai (small)” between the descriptions. In the example of the viewpoint and description extraction rule according to the invention, when a related plurality of descriptions based upon the same viewpoint are approved as one description, these descriptions are shown using a mark ‘&&’ like ‘$1&&$2’ (however, $1 and $2 are described) for example.

Next, the viewpoint and description extraction unit 120 adds element metadata ID for identifying the text in which the viewpoint and description pair emerges and individual viewpoint and description pair to the viewpoint and description pair regarded as corresponding to the viewpoint and description extraction rule and extracts according to the rule. An example of extracting a viewpoint and a description is shown in a table shown in FIG. 2C and showing the result of extracting element metadata. In the table showing the result of extraction, “1” on the left side in “1-1a” described in the highest field of an element metadata ID column denotes that the viewpoint “kaikou bu (open top)” and the description “30 cm” are extracted from the text 1. “1” in “1a” on the right side denotes that the viewpoint “kaikou bu (opening)” and the description “30 cm” are a viewpoint and a description hit first when the text 1 is retrieved and “a” denotes that it is a first description.

In this embodiment, an element metadata ID is added in a format like <text ID>-<number in text of viewpoint and description pair>. However, a mode of element metadata ID is not limited to this if only the identification of a text and the identification of a viewpoint and description pair are possible. A method of adding a syntactic attribute is not limited to the method described above, and syntactic analysis and configuration preliminary analysis may also be executed. In the above description, the viewpoint and description extraction unit 120 directly determines a syntactic attribute of a character string using the viewpoint and description extraction rule. However, the invention is not limited to this method, and a syntactic attribute may also be added to an input text beforehand or a syntactic attribute may also be added by an attribute addition unit (described later).

Next, the metadata comparison unit 106 respectively compares and collates viewpoints and descriptions in the extracted element metadata and estimates relevance between/among the element metadata. A method of collating viewpoints and descriptions is not particularly limited if only the syntactic attribute of a character string including a viewpoint and a description is used. For example, a method of comparing the conceptual similarity of a viewpoint or a word configuring a description using a thesaurus and further in addition to this, a method of estimating similarity based upon the syntactic relation of the viewpoint or the word configuring the description can be used. In this embodiment, viewpoints and descriptions are compared or collated using the result of extracting component words except a postpositional particle and an ending from a viewpoint and a description and examining whether the component words have syntactic relation or not and whether the component words have the same meaning or not using a thesaurus provided to the metadata comparison unit 106. Syntactic relation between component words extracted from viewpoints in texts 1 and 2 shown in FIG. 2A first is as follows.

Kaikou bu (Open top)→(Component word): kaikou, bu (Syntactic relation) Modification by participial adjective

Fasuna- no kaihei (zipping and unzipping by fastener)→(Component word): fasuna-, kaihei (Syntactic relation) Modification by participial adjective

Kawa no kanshoku (feel of leather)→(Component word): kawa, kanshoku (Syntactic relation) Modification by participial adjective

Kawa no tezawari (Touch of leather)→(Component word): kawa, tezawari (Syntactic relation) Modification by participial adjective

Iroai (coloring)→(Component word): iroai

Next, since “kanshoku (touch)” and “tezawari (touch)” out of the component words in the viewpoints “kawa no kanshoku (feel of leather)” and “kawa no tezawari (the touch of leather)” are recognized to be synonyms by the thesaurus and are also matched in the other component word “kawa (leather)” and the syntactic relation, it is determined that the two viewpoints “kawa no kanshoku (the feel of leather)” and “kawa no tezawari (the touch of leather)” are synonyms and have relevance. Similarly in relation to a description, it is determined that “shittori to yasashii (moist and soft)” in 1-3 in a field of element metadata ID and “shittori to yasashii—kanji expression—(moist and soft)” in 2-2 in the field of the element metadata ID are synonyms and have relevance. A method of determining the relevance of element metadata is not limited to the above-mentioned method if only determination is made based upon the result of collating viewpoints and descriptions and another method may also be adopted. For example, when the conceptual similarity of viewpoints and descriptions is numerically evaluated, it may also be determined that element metadata in which numerical values of viewpoints or descriptions are in a fixed range have relevance.

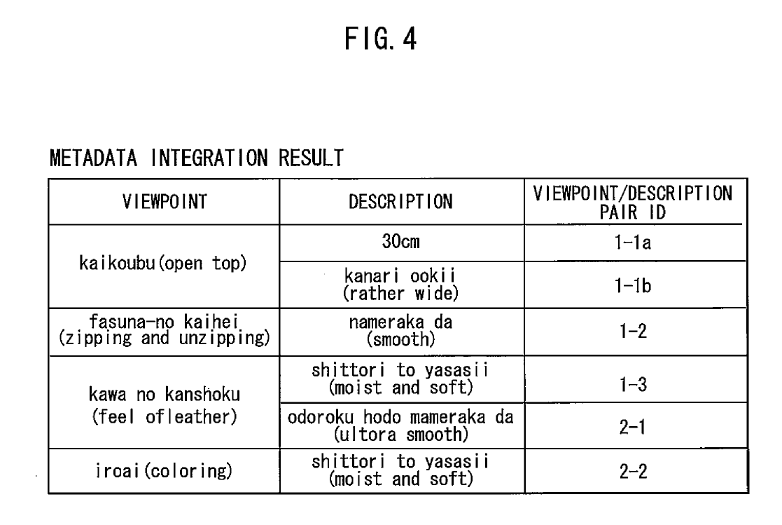

Next, the metadata integration unit 108 integrates element metadata based upon relevance between element metadata and stores them in the integrated metadata storage 110 as integrated metadata. A method of integrating metadata is not particularly limited. In this embodiment, however, (1) metadata having synonymous viewpoints are integrated and (2) metadata having synonymous viewpoints are integrated when the metadata have synonymous descriptions. In the example shown in FIGS. 2A to 2C, as it is determined that “kawa no kanshoku (feel of leather)” and “kawa no tezawari (touch of leather)” of viewpoints are synonyms, these viewpoints are integrated to be “kawa no kanshoku (feel of leather)”. As the descriptions “shittori to yasashii (moist and soft)” and “odoroku hodo nameraka da (ultra smooth)” which form pairs together with these viewpoints are not regarded as synonyms, they are not integrated. FIG. 4 shows an example of integrated metadata after such an integrating process. In the above description, plural texts are input, however, one text may also be input.

As described above, according to this embodiment, the contents of description such as a fact and an opinion related to a thing expressed in a text are configured as a pair of a viewpoint and a description, are arranged and extracted in a form in which relating the fact and the opinion and the comparison of relevance are easy, the fact and the opinion are further related using the result of extraction, and the related fact and opinion can be integrated.

### Second Embodiment

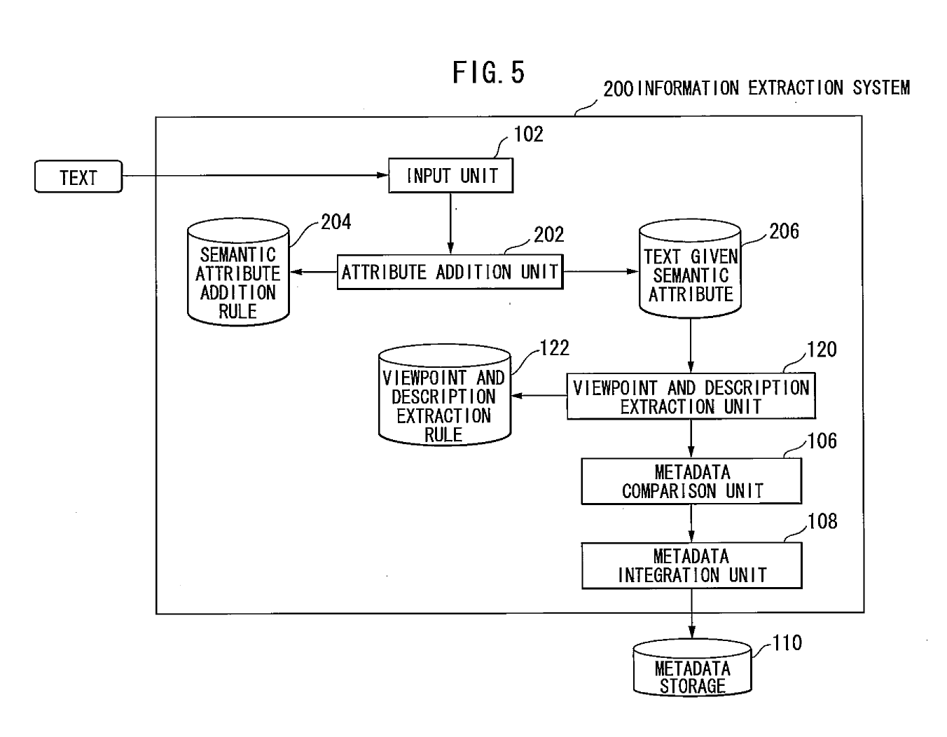

FIG. 5 is a block diagram showing the configuration of an information extraction system equivalent to a second embodiment of the invention. The information extraction system 200 has the similar basic configuration to the information extraction system 100 equivalent to the first embodiment shown in FIG. 1, the same reference numeral is allocated to the same component, and the description is omitted.

This embodiment is characterized in that the information extraction system 200 is provided with an attribute addition unit 202 that adds a semantic attribute to a character string in a text input from an input unit 102, a semantic attribute addition rule storage 204 that stores a semantic attribute addition rule for adding the semantic attribute to the character string and a storage 206 for storing the text to which the semantic attribute is added by the attribute addition unit 202. The text to which the semantic attribute is added as a result of a process by the attribute addition unit 202 is stored in the storage 206 for storing the text with the semantic attribute. In this case, a viewpoint and description extraction unit 120 extracts a viewpoint and a description from the text with the semantic attribute stored in the storage 206.

The attribute addition unit 202 identifies a character string such as a name of a thing and numeric representation (time, quantity and an amount) in the text and adds a semantic attribute to it. A method of adding the semantic attribute to the name of the thing and numeric representation is not particularly limited, however, a method of using a dictionary in which a semantic attribute is described every keyword and a method of utilizing proper noun extraction technique disclosed on pp. 107 to 114 of a document, “Comparison of Japanese and English in proper nouns extraction” written by Mr. Fukumoto and others, included in Information Processing Society of Japan Report 98-NL-126 and published in 1998 can be used.

The semantic attribute means semantic classification in which a name of a thing and numeric representation are classified based upon the meaning of each expression. When the semantic attribute has minute levels and when the corresponding expression is different from a general expression and a normalized form is required to be signified, the minute level and the normalized expression may also be described as the detailed information of the semantic attribute.

An example that the attribute addition unit 202 adds a semantic attribute to a name of a thing and numeric representation using the semantic attribute addition rule will be described below.

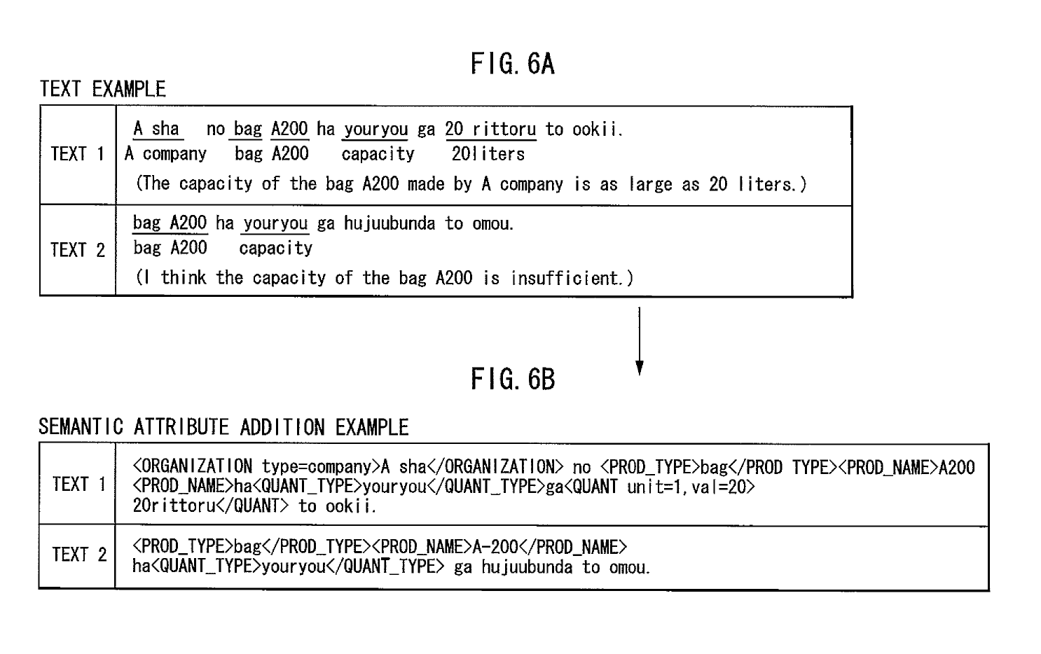

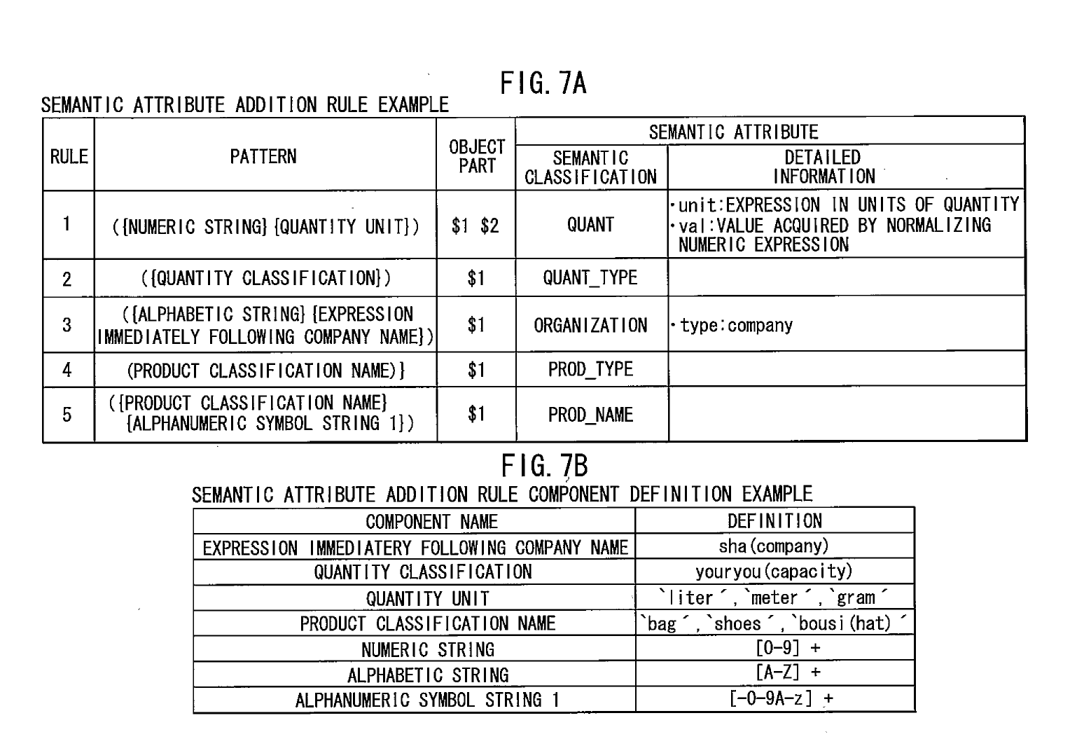

First, the attribute addition unit 202 checks whether or not an expression having a semantic attribute corresponding to the rule is included in a character string in the text input from the input unit 102 referring to the semantic attribute addition rule stored in the semantic attribute addition rule storage 204. As a result, the corresponding expression and the corresponding semantic attribute in the character string in the text are marked and the text with the semantic attribute is stored in the storage 206 for storing the text with the semantic attribute. FIG. 6A shows an example of input texts and FIG. 6B shows an example of the texts to which a semantic attribute is added. FIGS. 7A and 7B show an example of the semantic attribute addition rule and an example of the definition of components of the semantic attribute addition rule. A method of defining components is not particularly limited if only a name of a component and a character string or a list of character string patterns can be related. For example, a name of a component and the corresponding character string or the corresponding list of character string patterns may also be described in one file or the corresponding character string or the corresponding list of character string patterns may also be described in separate plural files. When the similar component is used in an example of the rule subsequently, the definition is omitted.

In the example shown in FIGS. 7A and 7B of the semantic attribute addition rule, a pattern for detecting an expression having the corresponding semantic attribute in the character string in the text, the semantic classification of the semantic attribute added to an object part of the expression corresponding to each pattern and detailed information are shown. In the rule pattern, a name of a component defined beforehand and corresponding to a character string pattern such as “numeric character continuation” or a word list such as “product classification name” is specified in the character string notation of the character string to which the semantic attribute is added. The notation of the rule pattern, $1 and $2 in the object part is similar to that of the rule shown in FIGS. 3A and 3B. In this example, “val” in the detailed information denotes a normalized value of numeric representation, “unit” denotes a normalized form of an expression in a unit of quantity, and “type” denotes the subordinate classification of the semantic attribute.

When the rule shown in FIGS. 7A and 7B is applied to the text 1 shown in FIG. 6A, semantic classification in a semantic attribute of “20 rittoru (20 liters)” is recognized as QUANT (quantity) and detailed information is recognized as [unit=1 (that means a unit is ‘1’), val=20 (that means a numeric value is ‘20’] respectively by the rule 1. Semantic classification in a semantic attribute of “capacity” is recognized as QUANT_TYPE (quantitative classification) by a rule 2. By a rule 3, semantic classification in a semantic attribute of “A sha (A company)” is recognized as ORGANIZATION (a name of an organization) and detailed information is recognized as [type=company (that means a type is “company name”]. As a result of recognition, the corresponding semantic classification in the semantic attribute and the corresponding detailed information are added and are stored in the storage 206 for storing the text with the semantic attribute as the text with the semantic attribute shown in FIG. 6B.

The notation of the semantic attribute addition rule is not limited to the above-mentioned notation and another notation may also be adopted. For a method of describing the pattern in the semantic attribute addition rule, a name of a component corresponding to the character string pattern and the word list is used in the above description, however, another descriptive method may also be used. For a method of specifying a condition on which the semantic attribute addition rule is applied, only the pattern is used in the above description. However, the invention is not limited to this and another method may also be adopted. For example, in addition to the pattern, a constraint related to a part of the pattern may also be separately specified and a method of specifying except the pattern may also be used. A text in which a semantic attribute is added beforehand may also be directly input to the viewpoint and description extraction unit 120.

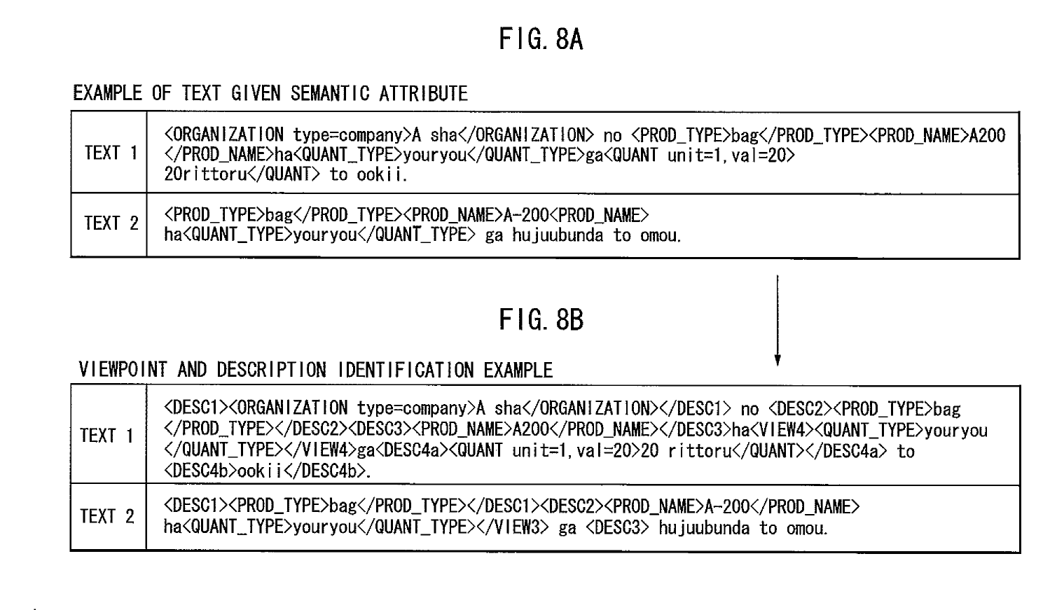

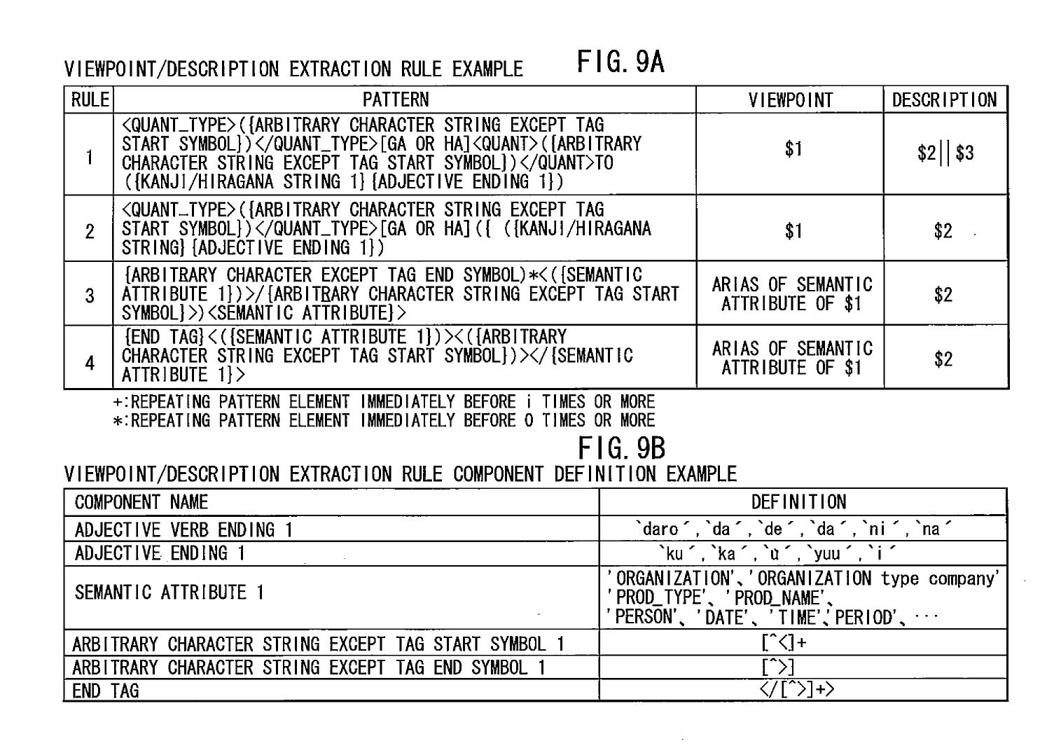

Next, the viewpoint and description extraction unit 120 extracts a viewpoint and description pair together with a semantic attribute from the text with the semantic attribute stored in the storage 206 for storing the text with the semantic attribute as element metadata. FIG. 8A shows an example of the text with the semantic attribute and FIG. 8B shows a viewpoint and description identification example. FIGS. 9A and 9B show an example of the viewpoint and description extraction rule for extracting a viewpoint and a description and an example of the definition of a component of the viewpoint and description extraction rule. The notation of the rule and a method of defining the component are similar to those shown in FIGS. 3A and 3B and the description is omitted.

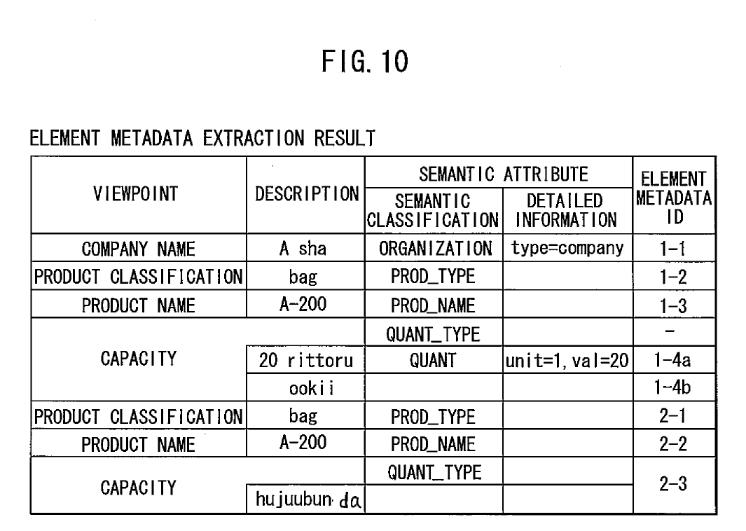

The viewpoint and description extraction rule shown in FIGS. 9A and 9B and the viewpoint and description extraction rule shown in FIGS. 3A and 32 in the first embodiment are different in that a semantic attribute added to the text is described as a part of a pattern in FIGS. 9A and 93. For example, in a rule 1 shown in FIGS. 9A and 9B, an arbitrary character string except a tag start symbol encircled by <QUANT_TYPE>, </QUANT_TYPE>, that is, a character string to which a semantic attribute of QUANT_TYPE (quantitative classification) is added is specified as a viewpoint. An arbitrary character string except a tag start symbol encircled by <QUANT>, </QUANT>, that is, a character string to which a semantic attribute of QUANT (quantity) is added is specified as a first description corresponding to the viewpoint. When the rule 1 shown in FIGS. 9A and 9B is applied to a text 1 shown in FIG. 8A, “capacity” to which the semantic attribute of QUANT_TYPE is added is equivalent to the viewpoint, “20 rittoru (20 liters)” to which the semantic attribute of QUANT is added is equivalent to the first description corresponding to the viewpoint, and “ookii (large)” is equivalent to a second description. Next, when a rule 3 shown in FIGS. 9A and 9B is applied to the text 1 shown in FIG. 8A, the character string “A sha (A company)” to which the semantic attribute of ORGANIZATION is added is equivalent to a description. Although the viewpoint corresponding to the description is not explicitly expressed in the text, when an alias is defined as a viewpoint for the semantic attribute according to the rule 3 shown in FIGS. 9A and 9B, “company name” is recognized as the viewpoint. FIG. 10 shows an example of the result of extracting a viewpoint and a description together with semantic classification and detailed information as element metadata to which element metadata ID that is identification information is added when the viewpoint and description extraction unit 120 similarly applies the rule shown in FIGS. 9A and 9B to the texts 1, 2 with the semantic attribute shown in FIG. 8A.

In the above description, the attribute addition unit 202 adds the semantic attribute of the character string. However, the invention is not limited to this. The attribute addition unit 202 may also add at least either of a syntactic attribute or a semantic attribute to the text, the viewpoint and description extraction unit 120 may also add at least either of a syntactic attribute or a semantic attribute using the viewpoint and description extraction rule or another rule, and at least either of a syntactic attribute or a semantic attribute may also be added to the input text beforehand.

In addition, in the above description, although the semantic classification and the detailed information are added as the semantic attribute, the added semantic attribute is not limited to this if only the semantic attribute includes the semantic classification and for example, the other semantic information except the detailed information may also be added.

Next, the metadata comparison unit 106 respectively compares and collates viewpoints and descriptions between/among the extracted element metadata, and estimates relevance. A method of collating by the metadata comparison unit 106 in this embodiment and that in the first embodiment are different in that the semantic attribute of the viewpoint and the description in the element metadata is used in collating. In this embodiment, when viewpoints and descriptions in the element metadata shown in FIG. 10 are respectively collated and the synonymous viewpoints and descriptions are acquired, the synonymous viewpoint or description, the synonymous viewpoints or the synonymous descriptions are also identified if the following condition is further met in addition to the method in the first embodiment.

An expression the semantic classification of which is “product name” and which is different in only whether or not ‘-’ is inserted into a boundary of an alphametric character in the expression.

According to the above-mentioned methods, it is determined that out of viewpoints and descriptions in the element metadata shown in FIG. 10, pairs of viewpoints “product classification” and descriptions “bag” in 1-2 and 2-1 and pairs of viewpoints “product name” and descriptions “A200” in 1-3 and 2-2 are synonymous and relevant, and it is determined that viewpoints “capacity” in 1-4a, 1-4b and 2-3 are synonymous and relevant.

A method of collating viewpoints and descriptions in metadata and a method of determining relevance in the element metadata are not limited to the above-mentioned methods. For the method of collating viewpoints and descriptions, a method of comparing and collating the conceptual similarity of words configuring viewpoints or descriptions using a thesaurus and a method of estimating similarity based upon syntactic relation between words configuring viewpoints or descriptions may also be used. A method of determining the relevance of element metadata is not limited to the above-mentioned method and when the conceptual similarity of viewpoints or descriptions is numerically evaluated, it may also be determined that element metadata in which a numeric value of the viewpoints or the descriptions is in a fixed range is relevant.

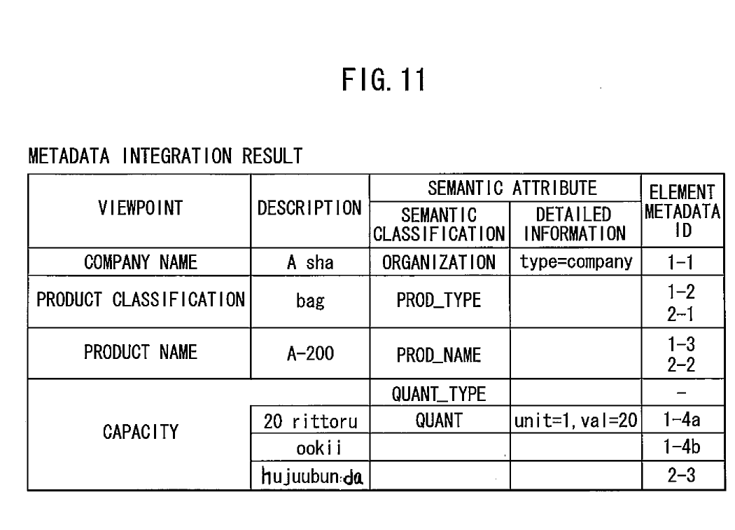

Next, the metadata integration unit 108 integrates the element metadata based upon the relevance of the element metadata as in the first embodiment and stores it in the metadata storage 110 as integrated metadata. In this embodiment, viewpoints and descriptions which meet the similar condition to that in the first embodiment are integrated and the detailed description is omitted. FIG. 11 shows an example of integrated metadata in which relevant element metadata is integrated and which is stored in the metadata storage 110 out of the element metadata shown in FIG. 10. In FIG. 11, the pairs of the viewpoints “product classification” and the descriptions “bag” which are synonymous viewpoints and descriptions in 1-2 and 2-1, the pair of the viewpoints “product name” and the descriptions “A200” in 1-3, and the pair of the viewpoints “product name” and the descriptions “A-200” in 2-2 are integrated. FIG. 11 shows that the respective viewpoints “capacity” of “20 rittoru (20 liters)” in 1-4a, “ookii (large)” in 1-4b and “hujuubun da (insufficient)” in 2-3 which are three different descriptions are integrated, “20 rittoru (20 liters)” which is quantity is expressed to be “ookii (large)” and “hujuubun da (insufficient)” as the capacity of this product and the product is differently evaluated in the text 1 and the text 2 respectively shown in FIGS. 8A and 8B.

As described above, according to this embodiment, the contents of description such as a fact and an opinion related to a thing expressed in a character string in a text with a semantic attribute can be easily extracted together with the semantic attribute of a viewpoint and a description. A fact and an opinion can be easily related and relevance can be easily compared by integrating the related fact and opinion using the result of extraction after determining the relevance more detailedly.

### Third Embodiment

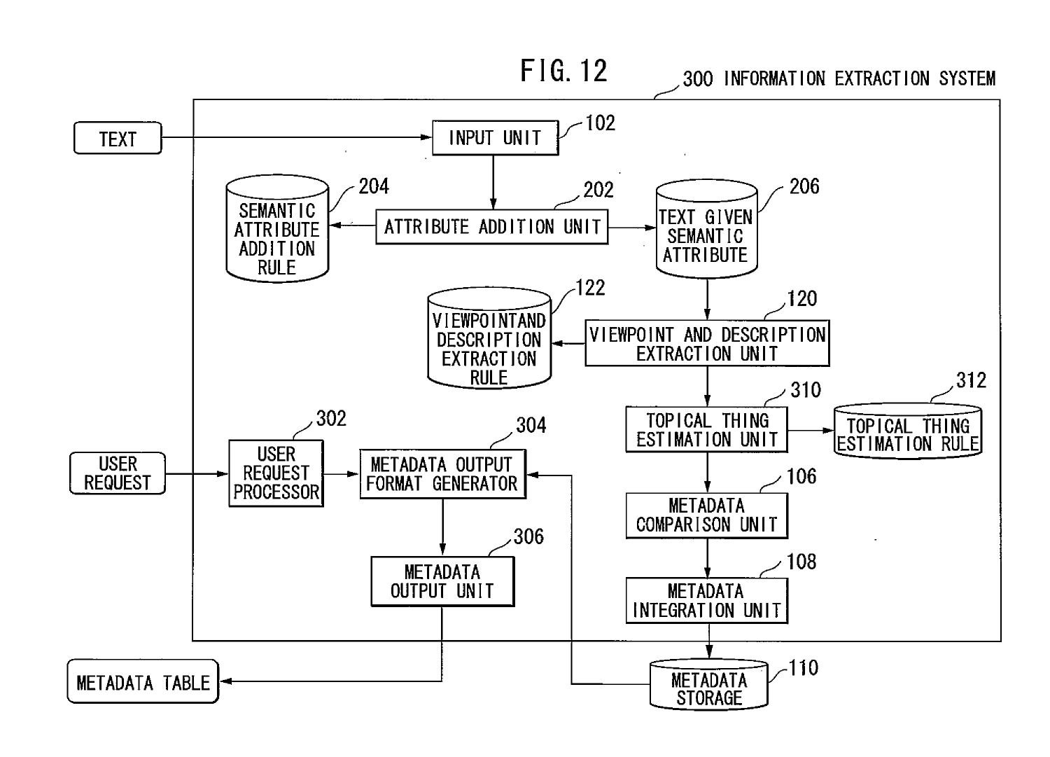

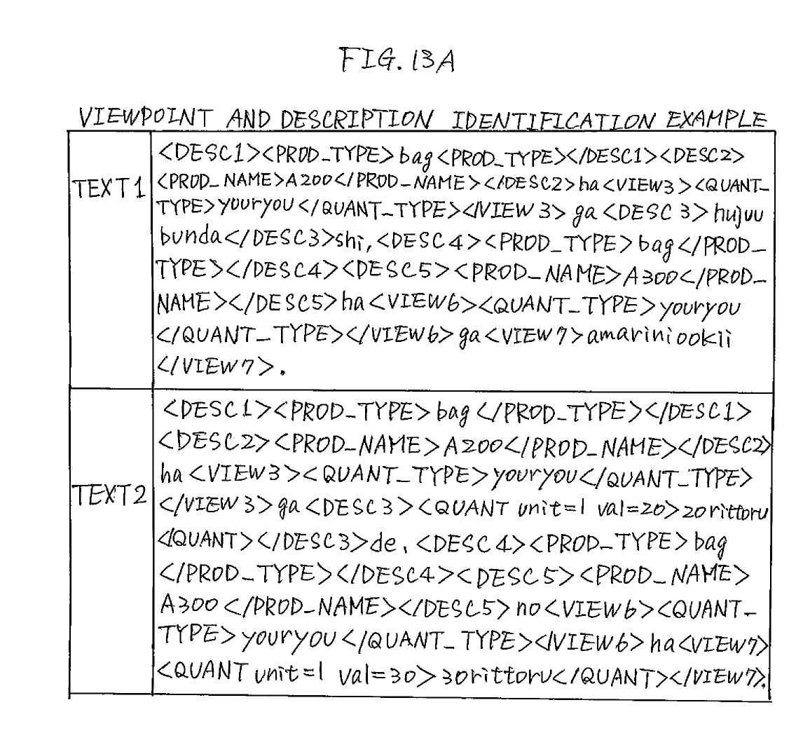

FIG. 12 is a block diagram showing the configuration of an information extraction system equivalent to a third embodiment of the invention. The information extraction system 300 has the similar basic configuration to that of the information extraction system 200 equivalent to the second embodiment shown in FIG. 5, the same reference numeral is allocated to the same component, and the description is omitted.

This embodiment is characterized in that the information extraction system 300 is provided with a user request processor 302 that processes a request from a user, a metadata output format generator 304 that arranges metadata and generates an output format of the metadata, a metadata output unit 306 that provides the output format of the metadata generated by the metadata output format generator 304 to the user, a topical thing estimation unit 310 that estimates a topical thing in element metadata extracted by a viewpoint and description extraction unit 120 and a topical thing estimation rule storage 312 that stores a topical thing estimation rule which is a rule for estimating the topical thing.

The topical thing means a name of a topical thing in element metadata showing about what thing each piece of element metadata is described. The topical thing is selected out of any description in element metadata denoting a name of the thing. A name of a thing to be a candidate of the topical thing is not particularly limited, however, a person's name, a place name, a name of an organization, an event name, a name of a creature and an artificial thing and their classification (example: a product name, product classification) are included.

The information extraction system 300 having the above-mentioned configuration will be described using a concrete example in detail below. Consider the following texts 1, 2.
Text 1: “Bag A200 ha youryou ga hujuubun da shi, bag A200 capacity insufficient
   A300 ha youryou ga amari ni ookii.”
   A300 capacity too large
   (The capacity of a bag A200 is insufficient, and that of a bag A300 is too large.)
Text 2:“Bag A200 ha youryou ga 20 rittoru de, bag A200 capacity 20 liters
   A300 no youryou ha 30 rittoru.”
   A300 capacity 30 liters
   (The capacity of the bag A200 is 20 liters, and that of the bag A300 is 30 liters.)

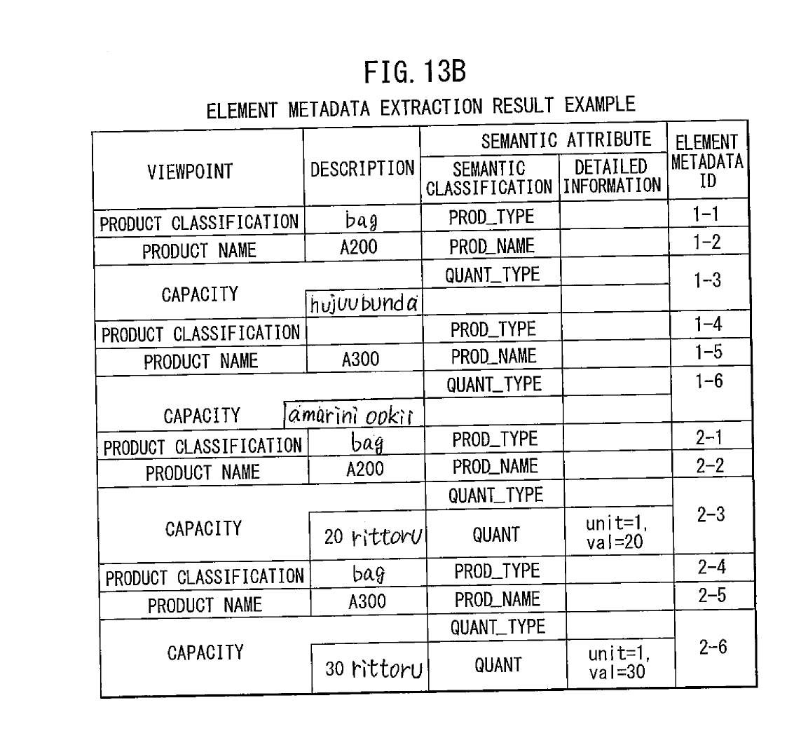

A flow of a process until the texts are input from an input unit 102, a semantic attribute is added by an attribute addition unit 202, a viewpoint and a description are extracted by the viewpoint and description extraction unit 120 and element metadata is extracted is similar to that in the second embodiment and the description is omitted. FIG. 13A shows an example of the result of applying semantic classification to the texts and extracting the viewpoint and the description and FIG. 13B shows an example of the result of extracting element metadata.

Next, the topical thing estimation unit 310 estimates a topical thing in the texts according to the topical thing estimation rule stored in the topical thing estimation rule storage 312. A method of estimating a topical thing is not particularly limited if only the topical thing estimation rule is used. The topical thing estimation unit 310 may also directly estimate a topical thing using the topical thing estimation rule. Alternatively, first, a type of element metadata to be a candidate of a topical thing is determined and afterward, the topical thing may also be estimated using the topical thing estimation rule. In that case, it is desirable that when the input texts may have plural types of topics such as a company name and a person's name, plural topical thing candidates are estimated and the topical thing estimation unit 310 can select a suitable topical thing. For example, when the topical thing candidate is estimated to be a description in element metadata the viewpoint of which is a product name or a person's name, the description in the element metadata the viewpoint of which is the product name or the person's name is estimated to be the candidate of the topical thing. In this case, the texts 1, 2 are descriptions in the element metadata having the product name as the viewpoint, and “A200” and “A300” are the topical thing candidates.

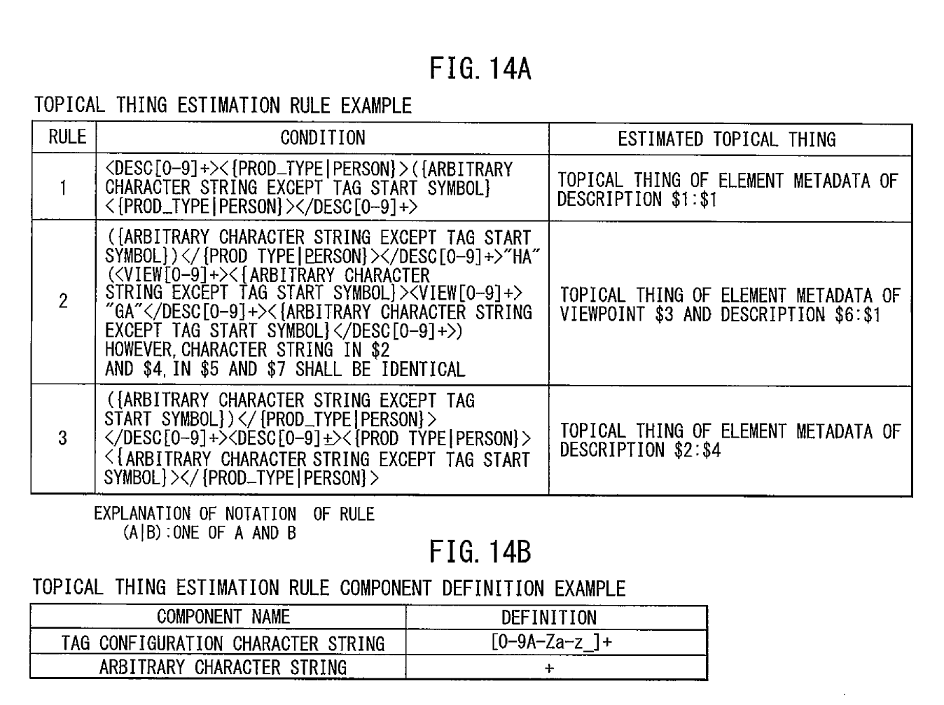

A case that the topical thing estimation unit 310 estimates a topical thing in the text according to the topical thing estimation rule stored in the topical thing estimation rule storage 312 will be described below. In this case, a topical thing is estimated by matching with a pattern described in a field of a condition, FIG. 14A shows an example of the topical thing estimation rule, and FIG. 14B shows an example of the definition of components of the topical thing estimation rule. The notation of the pattern in the field of the condition of the rule and a method of defining the components are basically similar to those shown in FIGS. 3A and 3B, however, in rules 2 and 3 shown in FIGS. 14A and 14B, in addition to the pattern, it is also added to a condition that character strings in a part of the patterns are identical.

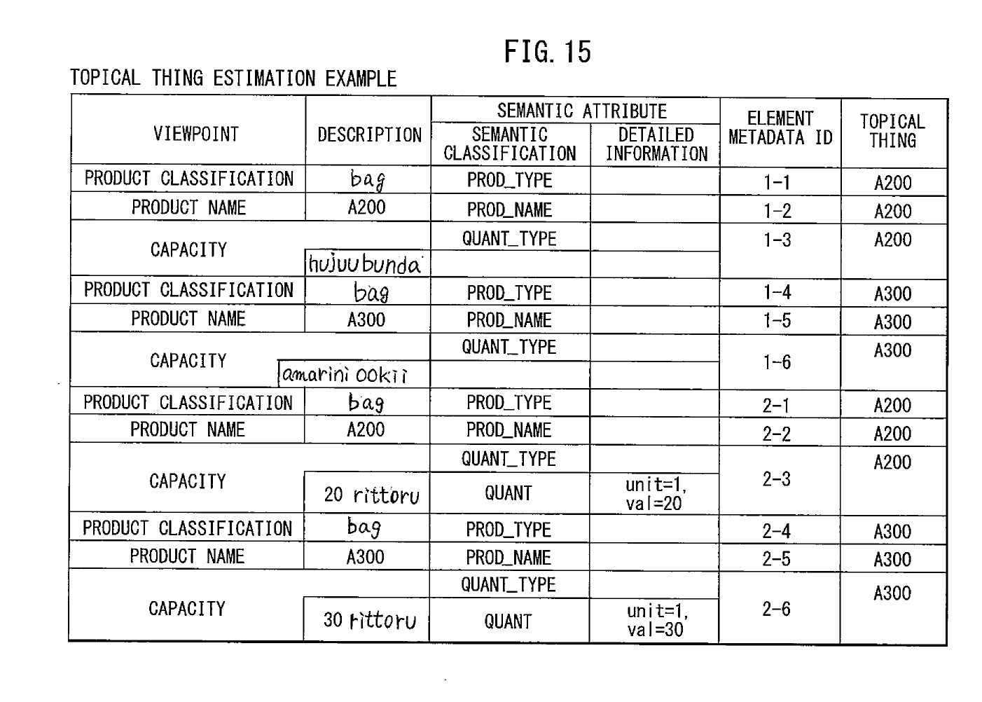

A topical thing of the element metadata shown in FIG. 13B is estimated based upon the texts 1, 2 shown in FIG. 13A using the rule shown in FIG. 14A. For example, when a rule 1 shown in FIGS. 14A and 14B is applied to the text 1, first, <DESC2><PROD_NAME><A200</PROD_NAME></DESC2>which is a second description is matched with a pattern described in a field of a condition of the rule 1 and according to the rule, a topical thing of “A200”, equivalent to $1 is estimated to be “A200” itself. Similarly FIG. 15 shows an example in which a topic of the element metadata shown in FIG. 13B is estimated based upon the texts 1, 2 shown in FIG. 13A using the rule shown in FIGS. 14A and 14B. A rule 3 shown in FIGS. 14A and 14B is applied to element metadata having element metadata IDs 1-1, 1-4, 2-1, 2-4 shown in FIG. 15, the rule 1 shown in FIGS. 14A and 14B is applied to element metadata having IDs 1-2, 1-5, 2-2, 2-5 shown in FIG. 15, and a rule 2 shown in FIG. 14A is applied to metadata having IDs 1-3, 1-6, 2-3, 2-6 shown in FIG. 15.

A method of estimating a topical thing is not limited to the above-mentioned method if only the topical thing estimation rule is used and for example, a viewpoint and a description in element metadata, a syntactic attribute, a semantic attribute or another attribute may also be specified according to a rule according to notation different from the above-mentioned notation. A rule different depending upon a type of a topical thing candidate may also be applied.

Next, the metadata comparison unit 106 respectively compares and collates viewpoints and descriptions in the extracted element metadata and estimates relevance. A method of collating viewpoints and descriptions in the element metadata is basically similar to that in the first or second embodiment, however, in this embodiment, they are also collated further using the result of the estimation of a topical thing.

In the example shown in FIG. 15, the element metadata having IDs 1-1, 1-2, 1-3, 2-1, 2-2, 2-3 has the same topical thing “A200” and the element metadata having IDs 1-4, 1-5, 1-6, 2-4, 2-5, 2-6 has the same topical thing “A300”. When synonymous viewpoints and descriptions are searched per piece of element metadata having the same topical thing as in the first embodiment, ID pairs of element metadata having the synonymous viewpoints and descriptions are 1-1 and 2-1, 1-2 and 2-2 first as to the element metadata the topical thing of which is “A200”. An ID pair of element metadata having the synonymous viewpoints is 1-3 and 2-3. It is estimated that the former viewpoints and descriptions and the latter viewpoints are relevant.

Similarly, as for element metadata the topical thing of which is “A300”, ID pairs of element metadata having the synonymous viewpoints and descriptions are 1-4 and 2-4, 1-5 and 2-5. An ID pair of element metadata having the synonymous viewpoints is 1-6 and 2-6. It is estimated that the former viewpoints and the descriptions and the latter viewpoints are relevant.

A method of collating by the metadata comparison unit 106 and a method of estimating relevance are not limited to the above-mentioned methods. In the above description, synonymous viewpoints and descriptions are searched per piece of element metadata having the same topical thing. However, after element metadata having synonymous viewpoints and descriptions are searched, element metadata having the same topical thing may also be searched and further a semantic attribute of element metadata may also be used.

Next, as in the first embodiment, a metadata integration unit 108 integrates element metadata and stores the integrated metadata in a metadata storage 110. Although a method of integrating element metadata is not limited, the following methods are adopted in this embodiment.

(1) Things having the same topic are integrated.

(2) Element metadata having the same topic and the same viewpoint are integrated.

(3) Synonymous descriptions, if any, in element metadata having the same topic and synonymous viewpoints are integrated.

Cases using these examples will be described below. As for element metadata having the same topical thing and having IDs 1-1, 1-2, 1-3, 2-1, 2-2, 2-3 out of the element metadata shown in FIG. 15, the topical things are integrated by the above-mentioned method (1). Similarly, as for element metadata having IDs 1-4, 1-5, 1-6, 2-4, 2-5, 2-6, topical things are also integrated. Next, as for element metadata having the same topical thing and synonymous viewpoints and having ID pairs 1-1 and 2-1, 1-2 and 2-2, 1-3 and 2-3, 1-4 and 2-4, 1-5 and 2-5, 1-6 and 2-6, the topical things and the viewpoints are respectively integrated according to the above-mentioned method (2). Further, as for element metadata having the same topical thing, having synonymous viewpoints and descriptions and having ID pairs 1-1 and 2-1, 1-2 and 2-2, 1-4 and 2-4, 1-5 and 2-5, the topical things, the viewpoints and the descriptions are integrated according to the above-mentioned method (3).

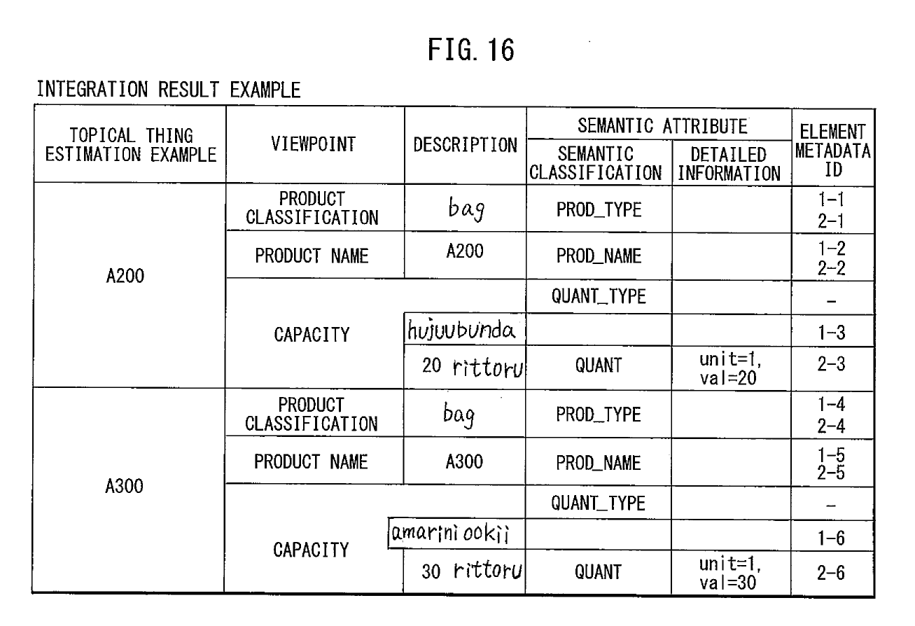

FIG. 16 shows an example of integrated metadata stored in the metadata storage 110 after the metadata integration unit 108 integrates the element metadata shown in FIG. 15 extracted based upon the texts 1, 2 as described above. The result of integration indicates that “the capacity” of “A200” is estimated to be “20 liters” and “insufficient”, while “the capacity” of “A300” is estimated to be “30 liters” and “too large”. A method of integrating metadata is not limited to the above-mentioned methods and if only integration is made based upon the relevance estimated by the metadata comparison unit 106 of viewpoints and descriptions of element metadata, another method may also be adopted. For example, element metadata having synonymous viewpoints and descriptions is first integrated and afterward, element metadata having the same topical thing may also be integrated.

Next, a request from a user is input to the user request processor 302 and an output format requested by the user is output to the metadata output format generator 304. The metadata output format generator 304 generates metadata in the output format requested by the user referring to the integrated metadata stored in the metadata storage 110 and provides the metadata to the user via the metadata output unit 306.

Next, a case that a metadata table as one example of the output format of metadata is generated according to specification in the request from the user will be described. First, the request from the user is input via the user request processor 302. In the request from the user input to the user request processor 302, either of some of element metadata including a topical thing or the combination of these metadata pieces is specified. For an example of a request from a user, a condition “(topical thing: A200) and (viewpoint: capacity)” is specified as a condition to be met of element metadata. The user request processor 302 checks a specification format in the request from the user and transmits the request to the metadata output format generator 304 if the specification format has no problem.

In this example, although the request from the user is input in the above-mentioned format, a request from a user may also be input in a free text (for example, “Tell me the capacity of A200.”). In the case of the latter, the user request processor 302 directly analyzes the text and may also extract the above-mentioned condition. The user request processor 302 once transmits a text in the request input by the user to the input unit 102 and may also analyze element metadata extracted by the viewpoint and description extraction unit 120 and the contents of a condition specified based upon their syntactic relation.

The metadata output format generator 304 selects the corresponding element metadata out of integrated metadata stored in the metadata storage 110 according to the contents of specification in the request from the user received from the user request processor 302 and makes the selected metadata correspond to the output format. For example, when the contents of the request from the user includes the specification of a topical thing, the metadata output format generator selects element metadata having the topical thing as a topic out of integrated metadata, further selects element metadata that meets a specified condition of a viewpoint and a description, and generates a metadata table having them. The metadata output unit 306 outputs the generated metadata table.

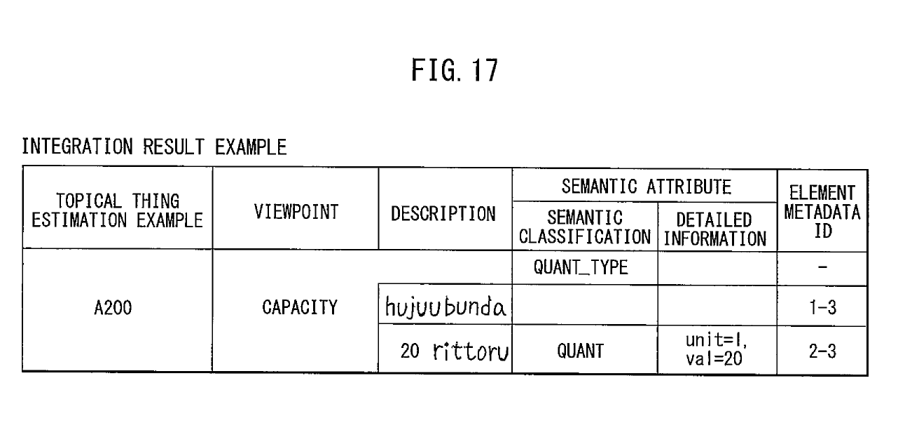

FIG. 17 shows an example of the metadata table generated by extracting only element metadata that meets the request from the user (topical thing: A200) and (viewpoint: capacity) out of the integrated metadata shown in FIG. 16. In this case, only the element metadata having “A200” as a topical thing and having “capacity” as a viewpoint is output as a table. For the output format of metadata, the metadata table is described above, however, for the output format, another format except a table may also be adopted.

As described above, according to this embodiment, the contents of description such as a fact and an opinion related to a thing expressed in a text and an estimated topical thing can be easily related. After the fact and the opinion are further more precisely related every topical thing using the result of extraction and relevance is more detailedly determined, the related fact and opinion can be integrated, can be arranged and extracted in a form that the relevance can be easily compared.

Information requested by a user is arranged and can be provided to the user by providing element metadata including a topical thing in a metadata output format arranged according to the specification of the user to the user.

### Fourth Embodiment

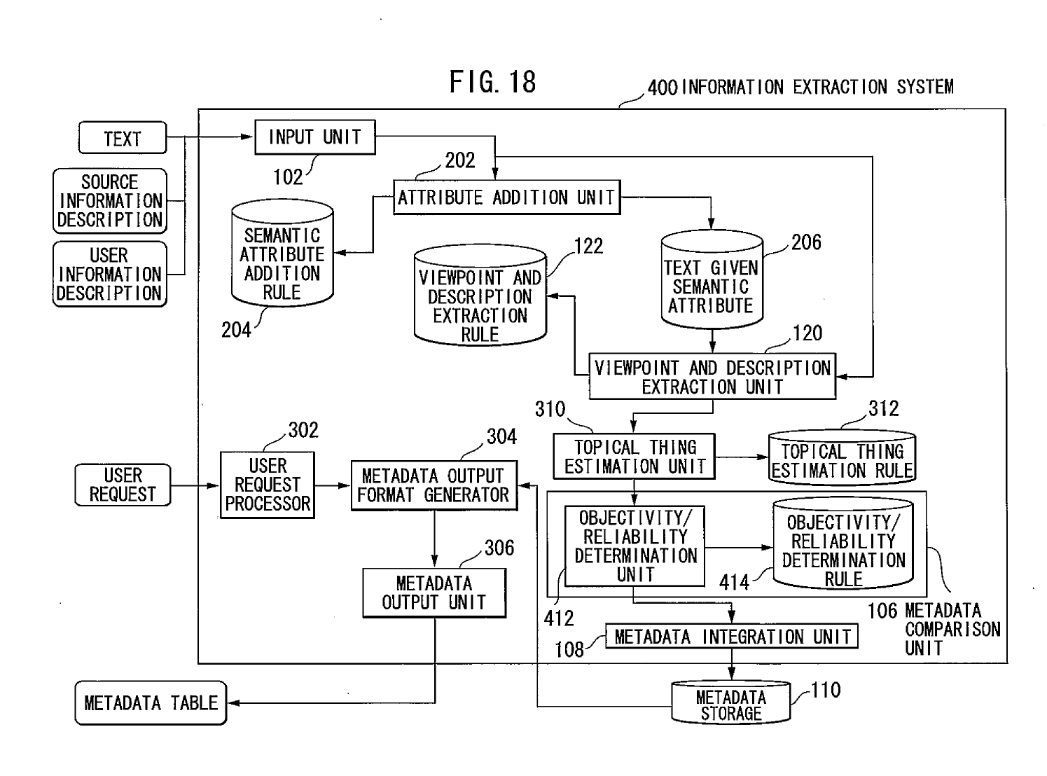

FIG. 18 is a block diagram showing the configuration of an information extraction system equivalent to a fourth embodiment of the invention. The information extraction system 400 has the similar basic configuration to that of the information extraction system 300 equivalent to the third embodiment shown in FIG. 12, the same reference numeral is allocated to the same component, and the description is omitted.

This embodiment is characterized in that the input unit 102 also receives source information and user information and a metadata comparison unit 106 is provided with an objectivity/reliability determination unit 412 that determines the objectivity and the reliability of a viewpoint and a description using element metadata, the source information or the user information and an objectivity/reliability determination rule storage 414 that stores an objectivity/reliability determination rule for evaluating objectivity and reliability.

Source information means the information of a bibliography related to an input text and the description of source information in the text is called a source information description. For an example of source information, a type of a text, a source of the text, the classification of a creator, the creator, an organization name and created time can be given. A source information description may also be input as a part of an input text if only relating to the text is possible and may also be input separately from the input text. Although a format of source information description is not particularly limited, source information shall be input together with the identification information of a text.

User information means information related to a creator of an input text and a description of user information expressed in a text is called a user information description. For an example of user information, the distinction of sex of a user, his/her age, occupation, place of employment and hobby can be given. A user information description may also be input as a part of a text if only relating to the text is possible and may also be input separately from the input text. A format of a user information description is not particularly limited, however, a user information description shall be input together with the identification information of a text.

A pair of a source information description and a viewpoint and description and a pair of a user information description and a viewpoint and description are called source metadata and user metadata. A source metadata ID or a user metadata ID respectively for identifying the corresponding text and individual source metadata or individual user metadata is added to source metadata or user metadata. A format of source metadata ID and user metadata ID is not particularly limited, however, as they are required to be related to a text, it is desirable that the format is a format in which the corresponding text ID can be estimated.

The objectivity/reliability determination unit 412 determines the objectivity and the reliability of a viewpoint and a description in element metadata using any of element metadata, source metadata and user metadata and the result of determination functions as evaluation data of the element metadata. The metadata integration unit 108 can integrate source metadata, user metadata and the evaluation data of element metadata in addition to element metadata. A user can specify necessary information using not only element metadata from the user request processor 302 but user metadata, source metadata and the evaluation data of element metadata and can acquire the corresponding metadata output format.

Next, the information extraction system 400 having the above-mentioned configuration will be described using a concrete example more detailedly. In this embodiment, a source information description and a user information description are input as a part of an input text and are described in a specific block of the input text.

A text is input from the input unit 102.

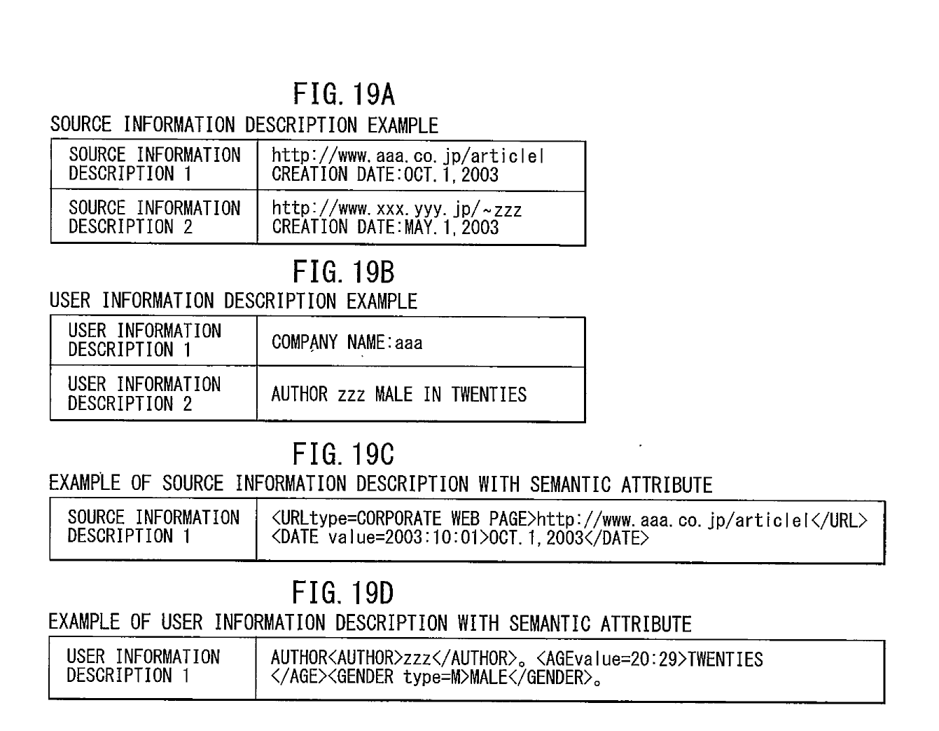

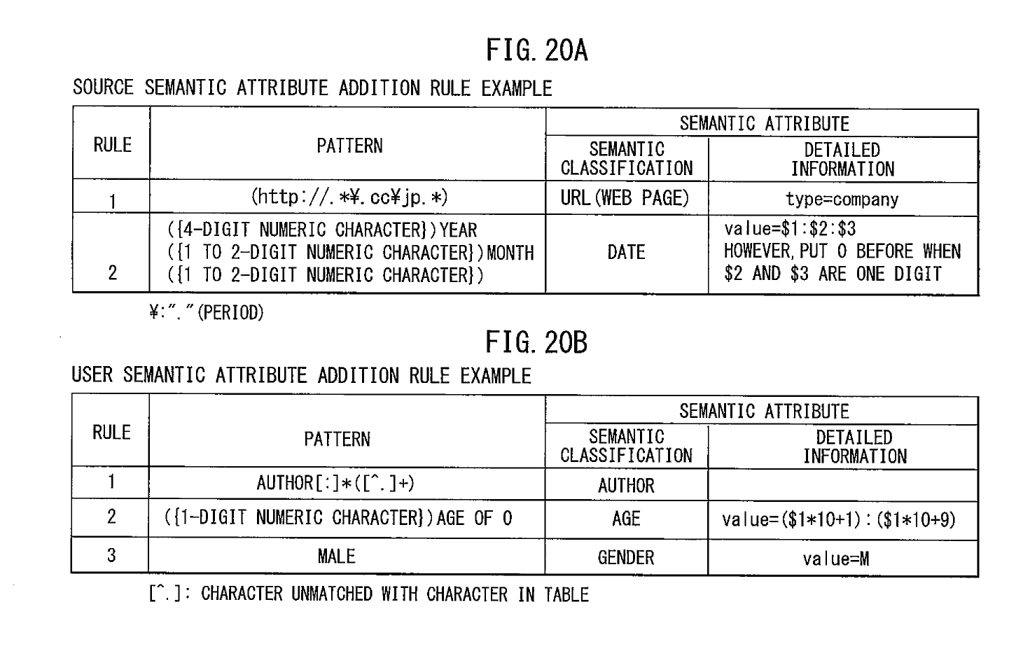

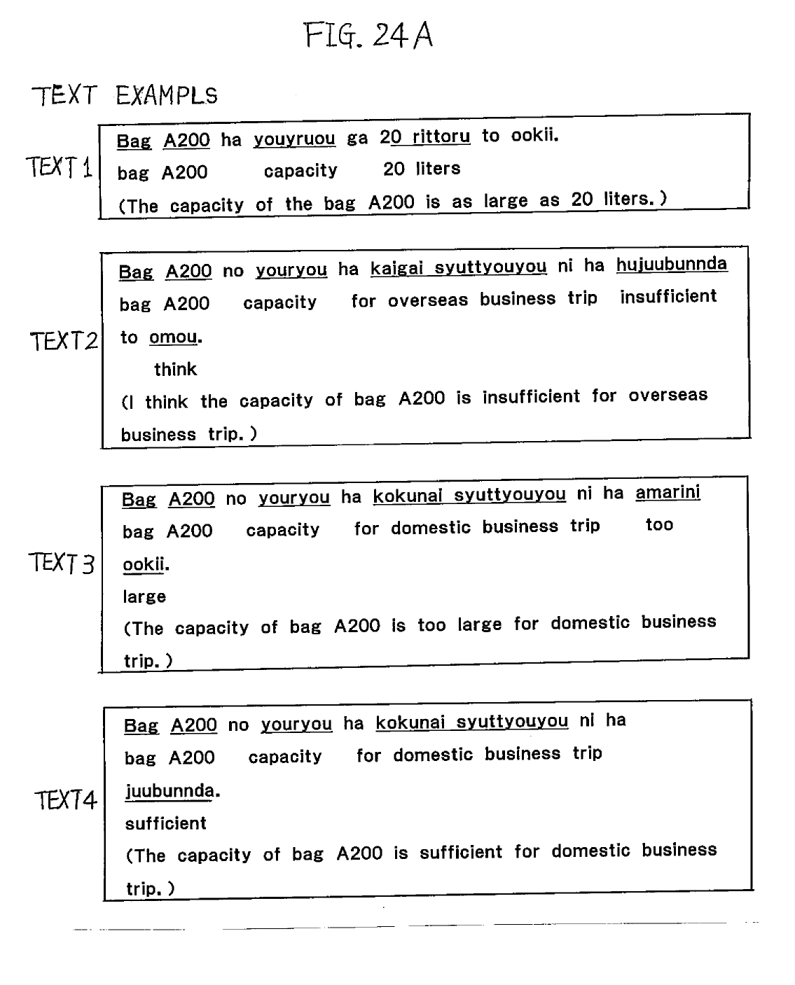

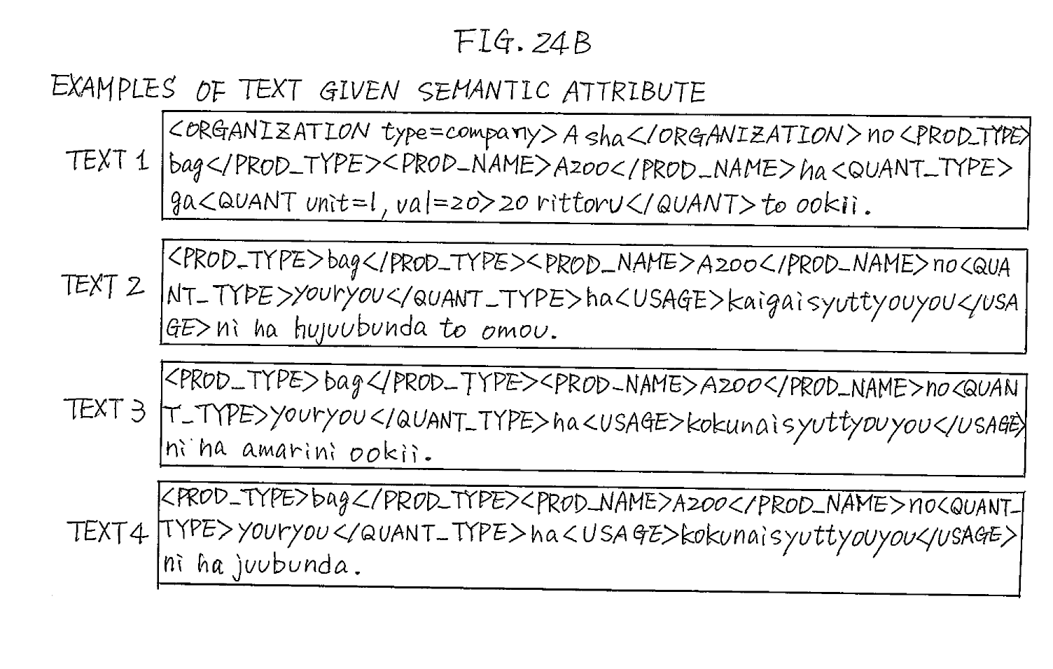

The attribute addition unit 202 adds a semantic attribute to the text including an input source information description or an input user information description using a semantic attribute addition rule and outputs the text with the semantic attribute to a storage for storing a text with a semantic attribute 206. FIG. 24A shows text examples 1 to 4 from which a block including a source information description and a user information description is removed. As a flow of the process up to the point is similar to that in the second and third embodiments, the detailed description is omitted. FIG. 19A shows an example of a source information description, FIG. 19B shows an example of a user information description, FIG. 19C shows an example of the source information description with a semantic attribute, and FIG. 19D shows an example of the user information description with a semantic attribute. FIG. 20A shows an example of a source semantic attribute addition rule and FIG. 20B shows an example of a user semantic attribute addition rule.

Next, a viewpoint and description extraction unit 120 extracts element metadata at least including a pair of a viewpoint and a description, source metadata or user metadata from the text with the semantic attribute stored in the storage for storing a text with a semantic attribute 206, source information with the semantic attribute or user information with the semantic attribute using a viewpoint and description extraction rule stored in a viewpoint and description extraction rule storage 122, a source viewpoint and description extraction rule or a user viewpoint and description extraction rule 122.

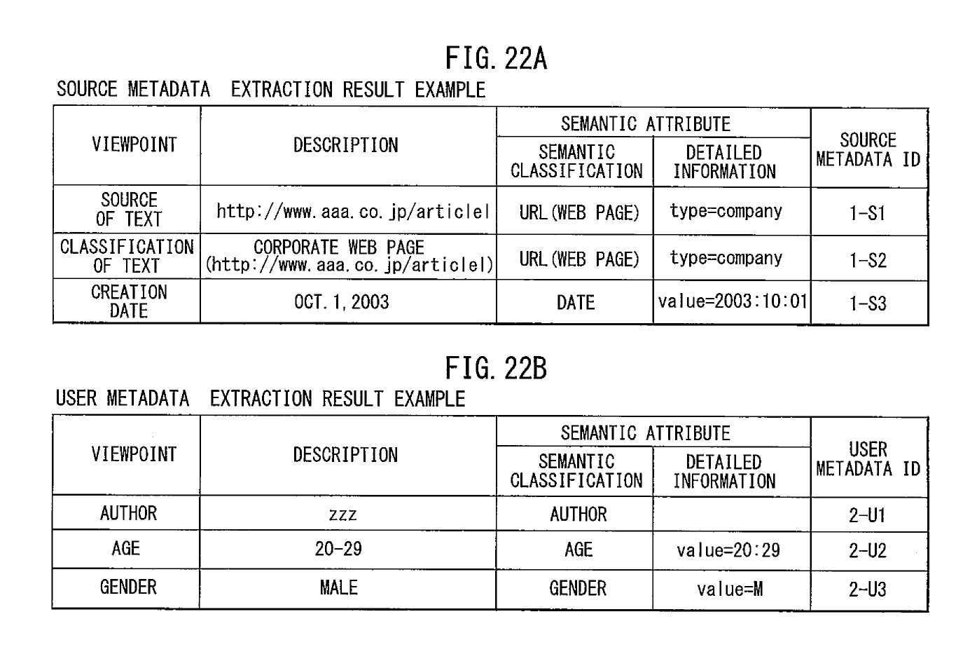

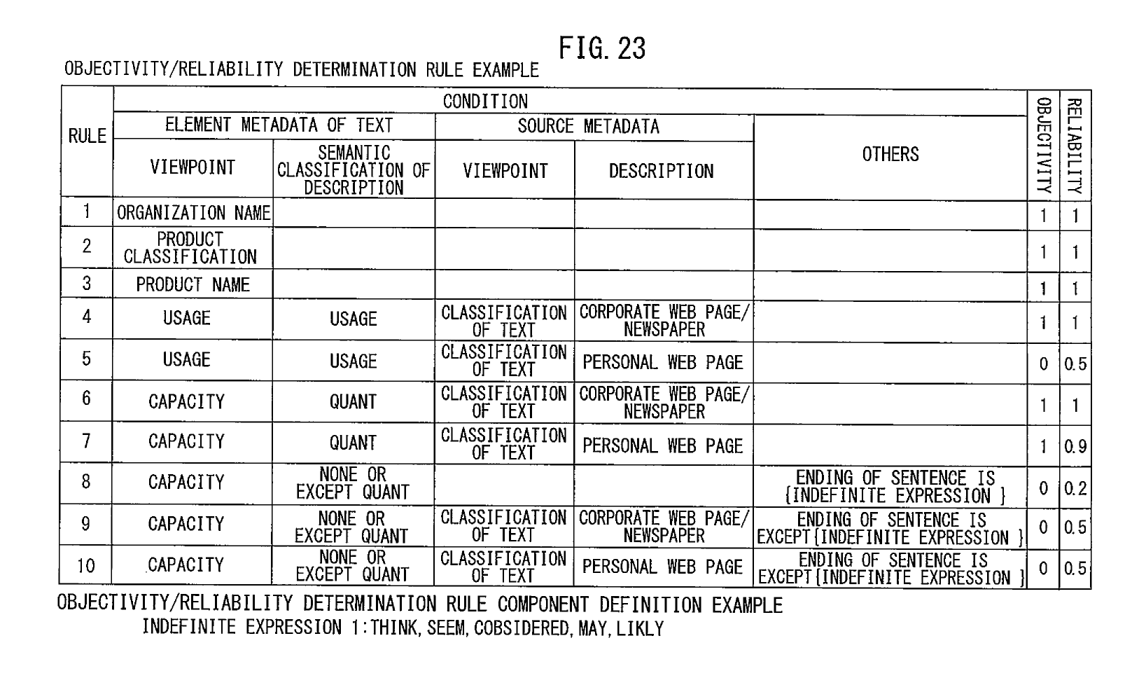

First, a case that the viewpoint and description extraction unit 120 extracts source metadata and user metadata from the block including the source information description and the user information description of the text with the semantic attribute will be described. When the viewpoint and description extraction unit extracts source metadata or user metadata, source metadata ID is added to each source metadata as shown in FIG. 22A and user metadata ID is added to user metadata as shown in FIG. 22B. In this embodiment, a source metadata ID and a user metadata ID are added in a format of <textID>-S<number in source information of viewpoint and description pair>, <text ID>-U<number in user information of viewpoint and description pair>. However, each format of source metadata ID and user metadata ID is not limited to this.

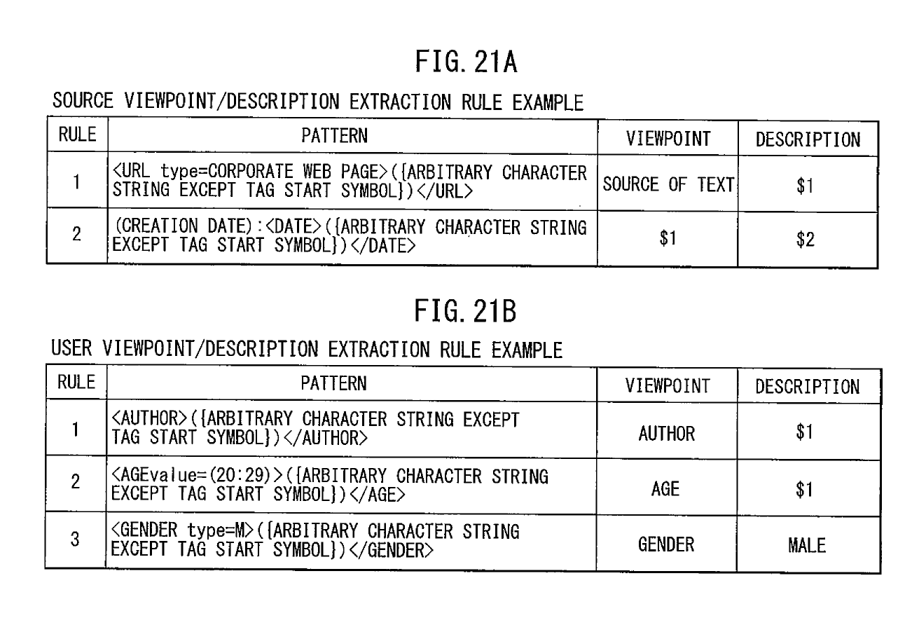

FIG. 21A shows an example of the source viewpoint and description extraction rule and FIG. 21B shows an example of the user viewpoint and description extraction rule. In the source viewpoint and description extraction rule shown in FIG. 21A and the user viewpoint and description extraction rule shown in FIG. 21B, like the viewpoint and description extraction rule in the first embodiment, the syntactic attribute and the semantic attribute of a character string equivalent to a viewpoint and a description or a character string in the circumference are specified in a pattern of the rule. For a method of specifying the syntactic attribute of a character string, notation is used in FIG. 21A and for a method of specifying a semantic attribute, the semantic classification of a semantic attribute and detailed information are used, however, the invention is not limited to these, only one of the syntactic attribute and the semantic attribute may also be specified, and for example, for the syntactic attribute, the classification of a part of speech may also be used.

A case that source metadata and user metadata are extracted from a source information description with a semantic attribute shown in FIG. 19C and a user information description with a semantic attribute shown in FIG. 19D using the source viewpoint and description extraction rule shown in FIG. 21A and the user viewpoint and description extraction rule shown in FIG. 21B will be described below. For example, when a source viewpoint and description extraction rule 1 shown in FIG. 20A is applied to the source information description with the semantic attribute shown in FIG. 19C, a character string shown in FIG. 19C <URL type-corporate web page s>http://www.aaa.co.jp/article1</URL> is equivalent to a pattern of the rule 1 and http://www.aaa.co.jp/article1 equivalent to a part encircled by first ‘( )’ in the pattern is equivalent to a description corresponding to a viewpoint “source of text” specified in the rule.

FIG. 22A and FIG. 22B shows each example of a result of the extraction of source metadata and a result of the extraction of user metadata respectively extracted from the source information description with the semantic attribute shown in FIG. 19C and the user information description with the semantic attribute shown in FIG. 19D using the source viewpoint and description extraction rule shown in FIG. 21A or the user viewpoint and description extraction rule shown in FIG. 21B.

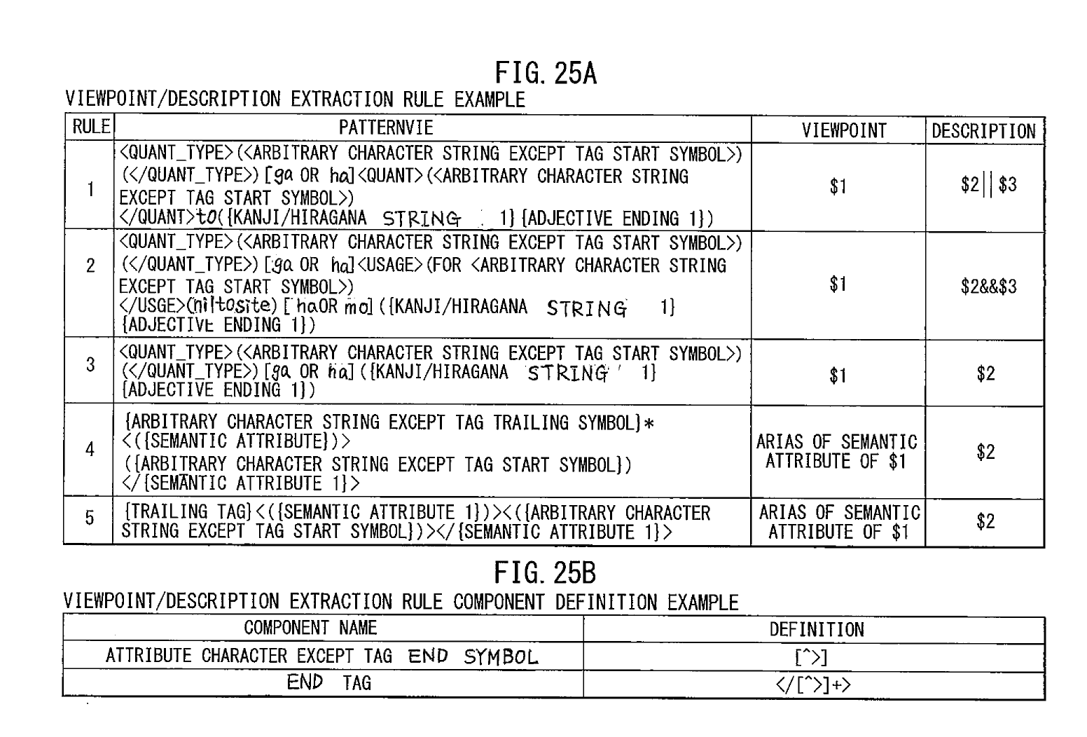

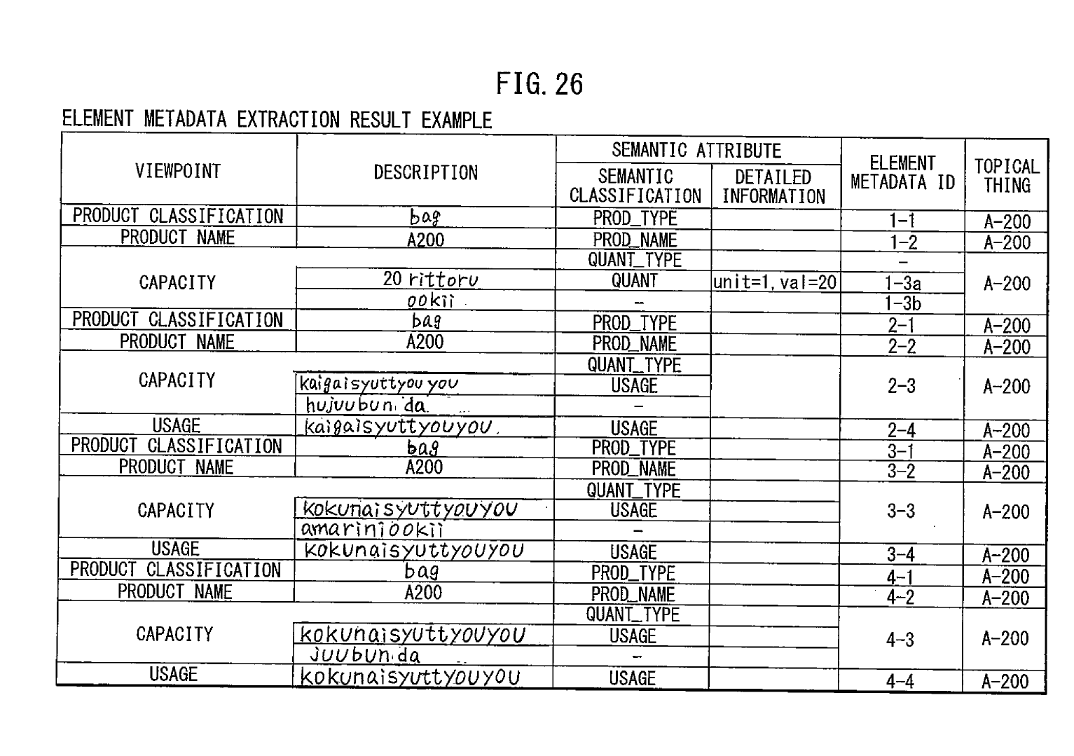

Next, a flow of a process until the viewpoint and description extraction unit 120 extracts element metadata from a location except for the block including the source information description and the user information description of the text with the semantic attribute and a topical thing estimation unit 310 estimates a topical thing will be described. FIG. 24B shows an example in which the attribute addition unit 202 adds a semantic attribute to each text shown in FIG. 24A and FIG. 25 shows an example of the viewpoint and description extraction rule. A viewpoint and a description are extracted from the text with a semantic attribute shown in FIG. 24B using the viewpoint and description extraction rule shown in FIGS. 25A and 25B as in the second or third embodiment. When a rule 1 shown in FIGS. 25A and 25B is applied to the text with the semantic attribute 1 shown in FIG. 24B, two descriptions “20 rittoru (20 liters)” and “ookii (large)” are extracted for a viewpoint “capacity”. Similarly, viewpoints and descriptions shown in FIG. 26 are extracted from the texts with the semantic attribute 1 to 4 shown in FIG. 24B using the rule shown in FIGS. 25A and 25B. Further, a topical thing is estimated based upon the texts with the semantic attribute 1 to 4 shown in FIG. 24B using the topical thing estimation rule shown in FIGS. 14A and 14B as in the third embodiment.

FIG. 26 shows an example of element metadata in which viewpoints, descriptions and their semantic attributes respectively extracted from the texts with the semantic attribute 1 to 4 shown in FIG. 24B by the viewpoint and description extraction unit 120 and topical things estimated based upon the texts with the semantic attribute 1 to 4 by the topical thing estimation unit 310 are arranged. FIG. 26 shows only some of the element metadata. In the third embodiment, although the method of estimating a topical thing using only information acquired from the text is described, metadata acquired based upon source information and user information may also be used.

Next, the objectivity/reliability determination unit 412 in the metadata comparison unit 106 determines the objectivity and the reliability of the element metadata using at least one of element metadata, source metadata and user metadata respectively extracted from the texts with the semantic attribute by the viewpoint and description extraction unit 120 according to the objectivity/reliability determination rule stored in the objectivity/reliability determination rule storage 414.

The objectivity of element metadata means whether the element metadata is objectively described or not, and it is considered that if a fact is described, the objectivity is high and if an opinion is described, the objectivity is low. The objectivity may also be represented as a numeric value and may also be represented by the classification of “fact”, “opinion” and others based upon a certain threshold or according to a condition of determination.

The reliability of element metadata means whether element metadata is reliable or not, and it is considered that the reliability of description written as an opinion on a personal home page is relatively low and the reliability of description written in a newspaper article as a fact is high. The reliability may also be represented as a numeric value and may also be represented by the classification of “reliability is high”, “reliability is low” and others based upon a certain threshold or according to a condition of determination.

At least one of element metadata, source metadata and user metadata is used for determining the objectivity and the reliability of element metadata. However, a syntactic attribute and a semantic attribute of a character string and statistical information may also be combined.

FIG. 23 shows an example of the objectivity/reliability determination rule. In FIG. 23, the objectivity is represented by 1 to 0 (1 shows that the objectivity is high and 0 shows that the objectivity is low) and the reliability is represented by 1 to 0 (1 shows that the reliability is high and 0 shows that the reliability is low). For example, in a rule 4, as to element metadata the viewpoint of which is “usage” and the semantic classification of the description of which is “usage”, it is determined that the objectivity is 1 and the reliability is also 1 when a source of the text of source metadata is “corporate web page”.

Next, an example in which as to element metadata shown in FIG. 26, the objectivity and the reliability are determined based upon element metadata of the text, source metadata and a syntactic attribute using the objectivity/reliability determination rule will be described.

Suppose that the following source metadata and the following user metadata are extracted from a block of a source information description and a user information description respectively corresponding to the texts 1 to 4 from which the element metadata shown in FIG. 26 are extracted in the input text by the viewpoint and description extraction unit 120.

Text 1

Source metadata
Viewpoint: Source of text
   Semantic attribute of description:
      Corporate web page
      Text 2

Source metadata
Viewpoint: Source of text
   Semantic attribute of description: Personal web page

User metadata
Viewpoint: Distinction of sex
   Description: Male
      Text 3

Source metadata
Viewpoint: Source of text
   Semantic attribute of description: Personal web page

User metadata
Viewpoint: Distinction of sex
   Description: Female
      Text 4

Source metadata
Viewpoint: Source of text
   Semantic attribute of description: Personal web page

User metadata
Viewpoint: Distinction of sex
   Description: Male

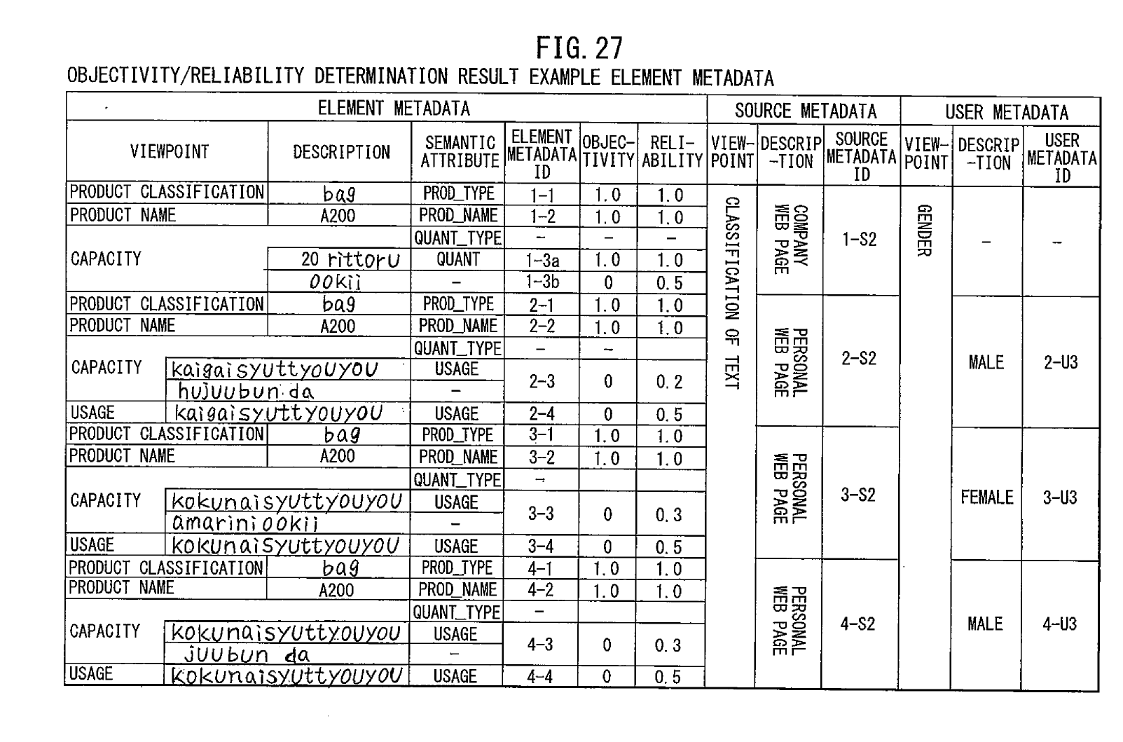

The objectivity and the reliability of the element metadata shown in FIG. 26 are determined based upon the above-mentioned source metadata and user metadata using the objectivity/reliability determination rule shown in FIG. 23. For example, in the case of element metadata shown in FIG. 26 the element metadata ID of which is 1-3a, as the viewpoint of the element metadata is “capacity”, the semantic classification of a description is “QUANT” and the text 1 from which the element metadata is extracted is on a corporate web page, a rule 6 shown in FIG. 23 is applied, and it is determined that the objectivity and the reliability are both 1. In the meantime, in the case of element metadata shown in FIG. 26 the element metadata ID of which is 1-3b, the viewpoint of the element metadata is “capacity”, the semantic classification of a description is “none”, the text 1 from which the element metadata is extracted is on a corporate web page and further, the ending of a sentence including the element metadata is “except indefinite expression 1”, since a rule 9 shown in FIG. 23 is applied, and it is determined that the objectivity is and the reliability is 0.5. FIG. 27 shows an example of the result of the determination of the objectivity and the reliability of the element metadata shown in FIG. 26 similarly determined based upon the above-mentioned source metadata and user metadata using the objectivity/reliability determination rule shown in FIG. 23 by the objectivity/reliability determination unit 412. The notation of the rule and the definition of components are similar to those shown in FIGS. 3A, 3B, 7A and 7B and the description is omitted.

For a condition of the objectivity/reliability determination rule, element metadata of the text, source metadata and a syntactic attribute are used in the above description. However, the invention is not limited to these if only at least one of element metadata, source metadata and user metadata is included. In the objectivity/reliability determination rule shown in FIG. 23, the semantic attribute of a description corresponding to the viewpoint “source of text” of source metadata is used for a part of a condition of the rule. However, a pair of another viewpoint and a description may also be used. For example, it may also be arranged such that it is determined that the reliability of element metadata which uses “created date” and the created date of which is old is low or that the reliability of a text which uses “creator” and which is written by a specific person is enhanced or lowered. When element metadata and other information are combined, the element metadata is combined with statistical information for example and the reliability of the element metadata having a description of multiple similar contents for the same viewpoint is enhanced. Or the reliability of element metadata having a description of the contents different from descriptions of multiple persons may also be lowered. In the objectivity/reliability determination rule shown in FIG. 23, the objectivity and the reliability are simultaneously determined by one rule. However, a rule for determining the objectivity and a rule for determining the reliability are distinguished and either may also be determined by one rule.

Next, the metadata comparison unit 106 respectively compares and collates viewpoints and descriptions of the extracted element metadata and estimates relevance. A method of collating viewpoints and descriptions by the metadata comparison unit 106 is not particularly limited. Although this embodiment is similar to the first, second or third embodiment, it may also be estimated using the data of the objectivity and the reliability that, of element metadata estimated to be highly related based upon the result of respectively collating viewpoints and descriptions, element metadata of which the values of the objectivity and the reliability are close has further higher relevance.

In the above description, source metadata and user metadata are used for only the determination of the objectivity and the reliability However, these may also be directly used when the metadata comparison unit 106 compares and collates element metadata. For example, when element metadata includes descriptions related to the capacity of a certain product and extracted from plural personal web pages, it may also be determined that the element metadata is highly relevant if descriptions of “distinction of sex” in their user metadata are the same and descriptions of “age” are in a fixed range.

Next, the metadata integration unit 108 integrates element metadata, source metadata, user metadata and element metadata including evaluation and stores the result of integration in the integrated metadata storage 110.

A method of integration is not particularly limited, however, the following methods (1) to (4) are given as an example below.

(1) Metadata having the same topic is integrated.

(2) Metadata having the same topic and synonymous viewpoints is integrated.

(3) Metadata having the same topic and synonymous viewpoints and having synonymous descriptions if any is integrated.

(4) Metadata having the same topic, synonymous viewpoints and synonymous descriptions and having the same semantic attribute is integrated.

In the case of the methods of integration (1) to (4), a case that the metadata integration unit 108 integrates element metadata shown in FIG. 27 will be described below. First, as the metadata shown in FIG. 27 all has the same topic “A200”, it is integrated based upon the common topic according to the above-mentioned method (1). Next, it is determined as in the first embodiment whether or not the viewpoint of each element metadata having the same topic is synonymous. When element metadata piece having these four viewpoints are integrated because only four types of viewpoints “product classification”, “product name”, “capacity” and “usage” are included in the example shown in FIG. 27 and these are not synonymous, element metadata the viewpoint of which is “product classification” and which has IDs 1-1, 2-1, 3-1, 4-1 is integrated, element metadata of which the viewpoint is “product name” and which has IDs 1-2, 2-2, 3-2, 4-2 is integrated, and element metadata of which the viewpoint is “capacity” and which has IDs 1-3a, 1-3b, 2-3, 3-3, 4-3 is integrated.

Next, it is determined as in the first embodiment whether or not descriptions in metadata having the same topic and having synonymous viewpoints are synonymous. In the example shown in FIG. 27, as descriptions in element metadata having the same topic “A200” and having the synonymous viewpoint “product classification” are all “bag”, these are regarded as synonymous and the descriptions in element metadata having IDs 1-1, 2-1, 3-1, 4-1 are integrated according to the above-mentioned method (3). Similarly, descriptions in element metadata having the same topic “A200”, having a synonymous viewpoint “product name” and having IDs 1-2, 2-2, 3-2, 4-2 and element metadata having a synonymous viewpoint “usage” and having IDs 3-4, 4-4 is also integrated. In the meantime, since it is not determined that descriptions “20 rittoru (20 liters)”, “ookii (large)”, “kaigaisyuttyouyou—hujuubun da (insufficient for overseas business trip)”, “kokunaisyuttyouyou—amari ni ookii (too large for domestic business trip)” and “kokunaisyuttyouyou—juubun da (sufficient for domestic business trip)” in element metadata having the same topic “A200” and having a synonymous viewpoint “capacity” are synonymous, the descriptions are not integrated.

Next, since semantic classifications in element metadata having the same topic “A200”, having the synonymous viewpoint “product classification” and the synonymous description “bag” are all “PROD_TYPE”, these are regarded as synonymous and the semantic classifications in element metadata having IDs 1-1, 2-1, 3-1, 4-1 are integrated according to the above-mentioned method (4). Similarly, semantic classifications in element metadata having the same topic “A200”, having the synonymous viewpoint “product name” and the synonymous description “A200” and having IDs 1-2, 2-2, 3-2, 4-2 and semantic classifications in element metadata having the synonymous viewpoint “usage” and the synonymous description “kokunaisyuttyouyou (for domestic business trip)” and having IDs 3-4, 4-4 are also integrated.

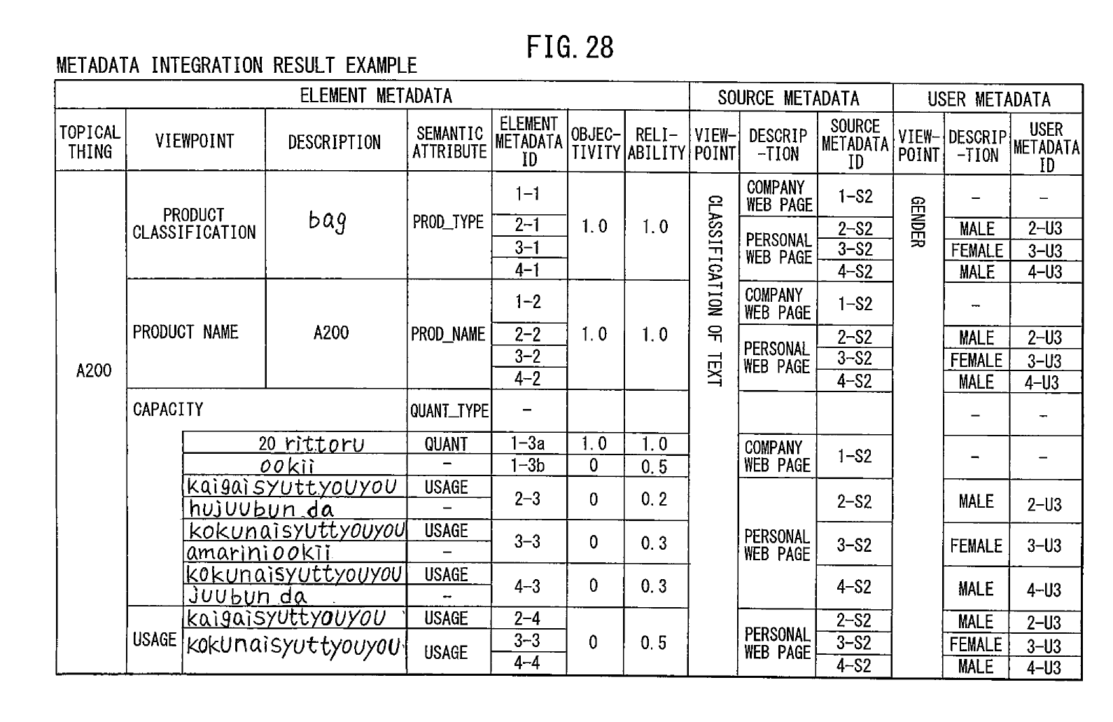

FIG. 28 shows an example of the result of integrating metadata stored in the integrated metadata storage 110 as a result of integrating the metadata shown in FIG. 27 by the metadata integration unit 108 as described above. In FIG. 28, a description is omitted in some of element metadata.

In the example shown in FIG. 28, information that “capacity” of “bag” called “A200” is “20 liters” is included as information of which the objectivity and the reliability are both high, that is, information in which the possibility that the information is a fact is high. As information related to the bag the objectivity of which is low, that is, information considered to be an opinion, though its capacity is estimated to be “large” on a corporate home page, the bag is estimated to be “insufficient” “for an overseas business trip” by one male, the bag is estimated to be “too large” “for a domestic business trip” by one female, and the bag is estimated to be “sufficient” by one male on a personal home page.

Next, the metadata output format generator 304 generates a metadata output format according to specification in a request from a user if the request from the user is specified by the user request processor 302 and provides the metadata output format to the user via the metadata output unit 306. However, a flow of a process till it is similar to that in the third embodiment. In this embodiment, though, the evaluation data of element metadata can also be specified as a request from a user. A case that the metadata output format generator 304 receives specification in the following request from a user including the evaluation data of element metadata as a result of integrating metadata shown in FIG. 28 and generates a metadata table including metadata matched with a condition specified by the user will be described as an example below.

Specification in request from user
Topical thing: A200
Objectivity: 0
Type of text: Personal web page

This specification demands a description “the objectivity of which is 0” as the evaluation data of a thing called “A200” and written in a text on a personal web page, that is, demands an opinion. The above-mentioned method is an example of a method of specification in a request from a user and the method is not limited to the above-mentioned method.

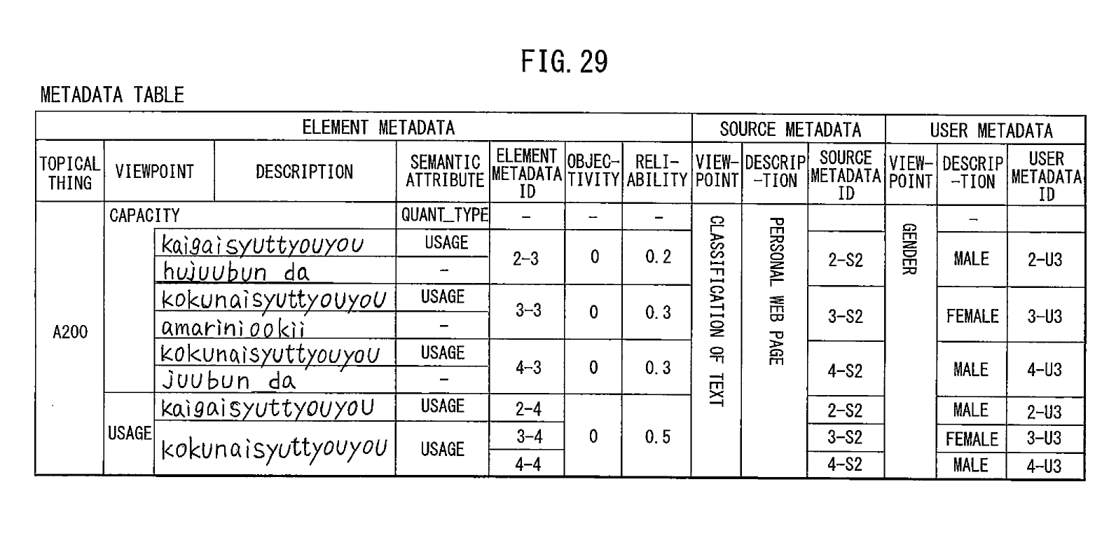

FIG. 29 shows an example of the metadata table generated as in the third embodiment according to the above-mentioned specification in the request from the user. The metadata table shown in FIG. 29 shows that as an opinion written in a text on a personal web page in relation to the thing called “A200”, viewpoints of capacity and a usage are adopted, that, as to a usage, two usages “for overseas business trip” and “for domestic business trip” are evaluated, and that, as to capacity, its capacity is estimated to be insufficient for an overseas business trip by one male, its capacity is estimated to be too large for a domestic business trip by one female and its capacity is estimated to be sufficient by one male.

As described above, according to this embodiment, the contents of a description such as a fact and an opinion related to a thing expressed in the text can be related and extracted together with an estimated topical thing. They are extracted so that the relevance of the extracted fact and opinion can be easily compared, and after the fact and the opinion are related every topical thing, they are provided to a user with the result of evaluating the objectivity and the reliability included. Hereby, information provided by the user is suitably interpreted and only information required by the user can be exactly selected.

The invention has been described based upon the preferred embodiments shown in the drawings, however, it is evident that this manufacturer can easily change and modify the invention, and a changed part is also included in the scope of the invention.

The information extraction system according to the invention is provided with the viewpoint and description extraction unit, the viewpoint and description extraction rule storage and the metadata storage and is useful as an information extraction system and an information retrieval system. The information extraction system according to the invention can also be applied to an information analysis/evaluation system and an information distribution system.

What is claimed is:

1. An information extraction system, comprising:
an input unit that inputs a text;
a viewpoint and description extraction rule storage that stores a viewpoint and description extraction rule for specifying the pairs of a viewpoint and a description for an expression in the text;
a viewpoint and description extraction unit that extracts the corresponding pairs of the viewpoint and its description of the expression using the viewpoint and description extraction rules that based on syntactic and/or semantic attributes and extract them as the element metadata to which identification information is added; and
a metadata storage that stores element metadata extracted by the viewpoint and description extraction unit.

2. The information extraction system according to claim 1,
wherein said syntactic attribute includes the character string notation and/or the classification of a part of speech.

3. The information extraction system according to claim 1,
wherein the semantic attribute includes semantic classification.

4. The information extraction system according to claim 1,
wherein the viewpoint and description extraction unit extracts the corresponding pair of the viewpoint and its description of the expression using the viewpoint and description as the element metadata to which identification information is added.

5. The information extraction system according to claim 1, further comprising:
an attribute addition unit that adds the semantic attribute including the semantic classification for character strings in a text using the semantic attribute addition rules and outputs the text added the semantic attributes.

6. The information extraction system according to claim 1,
wherein the viewpoint and description extraction unit extracts the corresponding pair of the viewpoint and its description using a semantic attribute of the description for the viewpoint when no viewpoint is explicitly expressed in a text and only the description is expressed.

7. The information extraction system according to claim 1, further comprising:
a metadata comparison unit that compares and estimates the respective relationships between the viewpoints and between the descriptions of element metadata extracted by the viewpoint and description extraction unit; and
a metadata integration unit that integrates related element metadata based upon the estimated relevance and outputs integrated metadata.

8. The information extraction system according to claim 6,
wherein the metadata comparison unit compares respective relationships between the viewpoints and between the descriptions of element metadata extracted by the viewpoint and description extraction unit using at least the semantic attributes of the character strings comprising the viewpoint and or description.

9. The information extraction system according to claim 7, further comprising:
a topical thing estimation unit that estimates a topical thing in element metadata extracted by the viewpoint and description extraction unit using a topical thing estimation rule for estimating a topical thing,
wherein the metadata storage also relates and stores the topical thing estimated by the topical thing estimated by the topical thing estimation unit together with the corresponding element metadata.

10. The information extraction system according to claim 9,
wherein the topical thing estimation unit estimates a topical thing of an element metadata based upon a viewpoints, descriptions, and semantic attributes of the element metadata stored in the metadata storage.

11. The information extraction system according to claim 9 or 10,
wherein the metadata comparison unit compares between viewpoints and between descriptions of the same topical thing estimated by the topical thing estimation unit.

12. The information extraction system according to claim 1,
wherein the viewpoint and description extraction rule includes a user viewpoint and description extraction rule which is a rule for specifying information on user who creates the text; and
the viewpoint and description extraction unit extracts user metadata which is element metadata related to the user information using the user viewpoint and description extraction rule.

13. The information extraction system according to claim 1,
wherein the viewpoint and description extraction rule includes a source viewpoint and description extraction rule which is a rule for specifying source information that describes the bibliography of the text; and
the viewpoint and description extraction unit extracts source metadata which is element metadata related to the source information using the source viewpoint and description extraction rule.

14. The information extraction system according to claim 9,
wherein the metadata comparison unit is further provided with an objectivity/reliability determination unit that determines objectivity and reliability of a viewpoint and a description using at least one of element metadata, user metadata and source metadata, and an objectivity/reliability determination rule storage that stores an objectivity/reliability determination rule for determining the objectivity and the reliability of the viewpoint and the description.

15. The information extraction system according to claim 9,
wherein when the topical thing estimation unit estimates a topical thing of element metadata, it estimates the topical thing using at least one of source metadata and user metadata in addition to the element metadata stored in the metadata storage.

16. The information extraction system according to claim 14, further comprising:
a metadata output format generator that arranges the metadata in a format of a table and generates a metadata table; and
a metadata output unit that shows the generated metadata table to a user.

17. The information extraction system according to claim 16, further comprising:
a user request processor that processes a request from a user,
wherein the metadata output format generator generates a metadata table using metadata matched with the request from the user input via the user request processor.

18. An information extraction method, comprising:
a step for inputting a text;
a step for referring to a viewpoint and description extraction rule for specifying a pair of a viewpoint of an expression described in the text and a description of the viewpoint; and
a step for extracting the pair of the viewpoint and its description based upon at least one of a syntactic attribute and a semantic attribute added to a character string in the text input to an input unit using the viewpoint and description extraction rule as element metadata relating the pair.
